SEQUENCE LISTING (12 sequences)

SEQ ID NO: 1 - DNA, 17 bp, Artificial Sequence
  primer
actgtgacggtcttcgc

SEQ ID NO: 2 - DNA, 21 bp, Artificial Sequence
  primer
gccgtgaagatggaatggatg

SEQ ID NO: 3 - DNA, 20 bp, Artificial Sequence
  primer
cactggcatggcttcttcca

SEQ ID NO: 4 - DNA, 21 bp, Artificial Sequence
  primer
aagtcgatgtggcagtggagg

SEQ ID NO: 5 - DNA, 520 bp, Pycnoporus sangineus
cctgaaaccggatggtgacgttgtcgccgggcgtgccggtgctcacgacgtcgcggaagaccgggttgtcgtagttgtactcgctgcttccggcgcttcggacgacagcgaaggtgtgctgcagtgatagtgaggtataaatttctcatcagatgcgtgatgagcggacgtacaccgtgcaggtggaaagggtgagggctgccaggagcattggcagtggcggggaaggagatctcaatagaggcgttgctcggcagaacgtagacgctgccttccggggaccaggtcctgtgcggcctgagcgccgctgagaatctggagcaggaccggcacggagggcgggacgaaggagtggtcattgatgaagaagttcgtgccgttctatatggacatcagacattgtcccgaattgtaggacgccggtgcgaatgctcacgaagttgaaaaccatgttcagcggcttgtcgacacctccgggctcggggcggccaggctatgatatgatatatgggtttcactc

SEQ ID NO: 6 - DNA, 564 bp, Pycnoporus sangineus
  misc_feature (115)...(115): n = a or g or c or t
agtcaaccagtgccccatcgcttcgggccattcgttcttgtacgacttccaggtccccgaccaagcaggtaatgaattcgacactcccctccactcggtgatactgacccttttnaactaggaacnttctggtatcacagtcatctatccacccagtattgtgatggattgagaggtcccttcgtcgtctacgacccgaatgatccccaggccagcttgtatgacattgacaacggtgagcagattggagccangtcacatactctcttctttcatactgaagccactcccagacgacactgtgattactttggccgactggtaccatcttgccgctaaagttggccagcgcttcccgtacgccttctcctatgtgtctcgatgtttcaagtggactcattgatgtgatgacagagttggcgcggatgcgactctgattaacgggcttggtcggacccccggnacgacctctgctgacctggcgattatcaaggtcacacagggcaagcggttcgtgcccatttatcaacctctaatcgcttgnctctgacaattctgctcttt

SEQ ID NO: 7 - DNA, 24 bp, Artificial Sequence
  primer
ggaactggttgctctggcagtacg

SEQ ID NO: 8 - DNA, 242 bp, Pycnoporus sangineus
  misc_feature (95)...(95): n = a or g or c or t
cggggaccaggtcctgtgcggcctgagcgccgctgagaatctggagcaggaccggcacggagggcgggacgaaggagtggtcattgatgaagaanttcgtgccgttctatatggacatcagacattgtcccgaattgtaggacgccggtgcgaatgctcacgaagttgaaaaccatgttcagcggcttgtcgacacctccgggctcggggcggccaggctatgatatgatatatgggtttca

SEQ ID NO: 9 - DNA, 559 bp, Pycnoporus sangineus
  misc_feature (3)...(3): n = a or g or c or t
atngttggtctgaaaccggatggtgacgttgtcgccgggggtaccggtgctcacgacgtcacggaagaccgggttgtcgtagttgnactcgcngcttccggcgcttcggacgacagcgaaggtgtgctgcagtgattgttagaaatcagctcatcatcaaaagcgcgatcagcggacgtacaccgtgcaggtggaaggggtgagggctgccaggagcattggcagtggcggggaaggagatctcaatagaggcgttgctcgggaggacgtacacgctgccttccgggaccaggtcctgtgcagcctgagcgccgctgagaatctggagcaggaccggcacggagggtgggacgaaagagtggttgttgatgaagaagttcgtgccgttctatatagacattagacattgttctaaaccataggacgccggcggcgtatatactcacgaagttgaagaccatgttgagcggcttggtcgacacctccgggctcggggcgtccaggctataatatgagagattagttttcatctactcgaatatttanatctgtacgagac

SEQ ID NO: 10 - DNA, 548 bp, Pycnoporus sangineus
  misc_feature (542)...(542): n = a or g or c or t
agtcaaccagtgccccatcgcttcgggccattcgttcttgtacgacttccaggttcccgaccaagcaggtaacgaaattttgacacccccctccactcggtgatactgatccttctttgattaggaactttctggtatcacagtcatctttccacccagtattgtgatggattgagaggccccttcgtcgtctacgacccgaatgatccccaggccagcttgtatgacattgacaacggtgagtaattttgagccaaatgacacactctcttgtcttatactgaaatccctaccagacgacactgtgattactttggccgactggtaccatcttgccgccaaagttggacagcgcttcccgtacgccttgtcttatgtgtctcgatgtttcaagtggactcattgtcgtgatgacagagttggcgcggatgcgactctgattaacgggcttggtcgaacccccggcacgacctctgctgatctggcggttatcaaggtcacacagggcaagcggttcgtgtccaatatcaacttatactcgntttgct

SEQ ID NO: 11 - DNA, 419 bp, Pycnoporus coccineus
  misc_feature (12)...(12): n = a or g or c or t
ctggccggtgcncacgacgtcgcggangancgggttatcgtagttgtactcgnggcttccggagcttcggacgacagcgaaggtgngctgngtgtgattgttagctatcaactcatcatcagatgcgcgaggaccggacntacaccgtgcaggtggaaggggtgaggngtgccaggagcattggcagttgcggggaaggagatctcaatagacgagttgctcgggagaacgtagacgctgccgtccggaacgaggtcctgcgcggcctgagcaccgctgagaatctggagcagaaccgggacggagggtgggacaaaggagtgattgttgatgaagaagttggtgccgttctgcaaggacatcananattgtcccaaaatggcgcgaaggcaatgctcacnaagttgaaagaccatgtt

SEQ ID NO: 12 - DNA, 111 bp, Pycnoporus coccineus
  misc_feature (84)...(84): n = a or g or c or t
gtcaaccagtgccccatcgcttcgggccattcgttcttgtacgacttccaggttcccgatcaagcaggtaatgaaattcgaccngntctttcattcggcgggcctgatctc

(19) United States
(12) Patent Application Publication
(10) Pub. No.: US 2005/0067347 A1
(43) Pub. Date: Mar. 31, 2005

(54) Sustainable process for the treatment and detoxification of liquid waste

(76) Inventors: Sophie Vanhulle, Chastre (BE); Mathias Lucas, B-Brussels (BE); Valerie Mertens, Boui (BE); Benoit Gobeaux, Brugelette (BE); Anne Marie Corbisier, Louvain-La-Neuve (BE); Christian-Marie Bols, Chastre (BE); Frederic Buchon, Basecles (BE); Dirk Wesenberg, Halle (DE); Soyridon Agathos, Bruxelles (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/489,119

(22) PCT Filed: Sep. 9, 2002
(86) PCT No.: PCT/EP02/10077

Related U.S. Application Data
(60) Provisional application No. 60/318,888, filed on Sep. 10, 2001.

(51) Int. Cl. C02F 3/00

(52) U.S. Cl. 210/606

(57) ABSTRACT

A method for treatment of liquid waste is disclosed that includes the steps of (a) submitting the liquid waste to a pretreatment and (b) submitting the pretreated liquid waste to the action of fungi or active agents thereof. In particular, the described process is useful for the effective decoloration and detoxification of dye-containing liquid wastes using white rot fungi or active agents thereof.

### FIELD OF THE INVENTION

The present invention relates to a sustainable process for the treatment of and detoxification of liquid waste. In particular the invention relates to a process for the effective decoloration and detoxification of liquid waste containing dyes.

### BACKGROUND OF THE INVENTION

A great variety of synthetic dyes are used in numerous industries for textile and leather dyeing, paper printing, color photography, and as additives in petroleum and cosmetic products. Their structural diversity derives from the use of different chromophoric groups such as azo groups, anthraquinonic groups, etc. The total world colorant production is estimated to be in the region of 800,000 tons/year. During the dyeing process up to 15% of the dyes are released into liquid industrial wastes. Most of these compounds are highly resistant to microbial attack and are hardly removed from effluents by conventional biological, physical or chemical treatments. In addition to visual pollution, there is a considerable risk of toxicity toward living organisms, possibly due to derivatives generated during bio-transformation. Textile dyes resist fading upon exposure to sweat, light, water and oxidizing agents. They are very stable and difficult to degrade. They are not degraded neither by activated sludge nor by aerobic bacterial isolates. Reductive anaerobic cleavage of these dyes results in carcinogenic compounds being generated. In other words, there is a problem of water pollution from the dye complexes, which are discharged into public water supplies. These organic substances render the effluents highly colored and make them toxic.

Bio-decoloration of lignin-containing pulp and paper wastewater using white-rot fungi Phanerochaete chrysosporium and Tinctoporia sp. (Eaton, et al., 1980; Fukuzumi, et al., 1980) were clear examples of color removal through microbial degradation of the colored substances, i.e., highly chlorinated and oxidized polymeric lignin molecules. As for dye color removal, Groff and Kim, 1989, described the ability of Rhodococcus, Bacillus cereus and Plesiomonas/Achromobacter to degrade soluble dyes, acid red dye and five azo-dyes, respectively.

Above reviewed bio-decoloration reports limit their studies primarily in defined laboratory model systems. Their actual application and effectiveness towards highly colored industrial liquid waste were not particularly emphasized. Though limited, successful examples of bio-decoloration of pulp and paper wastewater using white-rot fungi (U.S. Pat. No. 4,655,926) were reported. U.S. Pat. No. 5,091,089 further discloses a biological approach through the use of white-rot fungi for the decoloration of dye wastewater. The former demonstrated the use of a rotating biological contactor and strains of white-rot fungi from the genus Myrothecium and the genus Ganoderma to remove color in waste liquor without giving quantitative results, while the latter claimed a substantial color removal through a mechanism of dye adsorption. However, in some environmental legislation, adsorption is considered as a pollution transfer since the xenobiotic molecules are not destroyed but are concentrated and must be transferred into dumping grounds.

There is a need to substantially remove the color from industrial effluents and to further detoxify certain refractory organic compounds contained in said effluents.

It is a main object of the invention to provide with a process for the treatment of liquid waste. It is another object to provide with a process, which permits the effective decoloration of liquid waste. It is a further object of the invention to provide with a process, which permits the effective detoxification of said liquid waste. It is yet a further object of the invention to provide with a process, which permits the reduction of the mutagenicity of said liquid waste.

### SUMMARY OF THE INVENTION

The present invention is related to a unique and effective process to efficiently decolorize and detoxify liquid waste such as industrial effluents. The present invention relates to a process for the treatment of liquid waste, comprising the steps of (a) submitting said liquid waste to a pretreatment and (b) submitting said pretreated liquid waste to the action of fungi or active agents thereof. This process permits the effective decoloration, but also simultaneously the efficient detoxification of said liquid waste. Moreover, the combination of said pretreatment with a treatment with white-rot fungi or active agents thereof, increases the biodegradability of said liquid waste, and totally eliminates the mutagenicity of said liquid waste.

In an embodiment, the invention is related to a process for the treatment of liquid waste, comprising the steps of
a) submitting said liquid waste to a pretreatment,
b) submitting said pretreated liquid waste to the action of white-rot fungi or active agents thereof.

In another preferred embodiment, the white-rot fungi active agents comprise hydrolytic enzymes, cellulolytic enzymes, or ligninolytic enzymes.

In a more preferred embodiment said white-rot fungi active agents consist essentially of laccase enzymes.

In a more preferred embodiment said liquid waste, is dye containing liquid waste, comprising azo dyes and anthraquinones dyes In another more preferred embodiment said liquid waste comprises humic acids.

A possible pretreatment is ozonisation. Another preferred pretreatment is the adsorption of said waste on a biodegradable support.

In an embodiment, said fungi are lignicolous fungi, more preferably white-rot fungi. In yet another embodiment said fungi are selected from the group consisting of the genus Acanthophysium, the genus Aleurobotrys the genus Aleurodiscus, the genus Amphinema, the genus Amylostereum, the genus Armillaria, the genus Aspergillus, the genus Asterostroma, the genus Auricularia, the genus Botryobasidium, the genus Botryohypochnus, the genus Calocera, the genus Chaetomium, the genus Cladorrhinum, the genus Clitocybula, the genus Columnocystis, the genus Coriolopsis, the genus Cystostereum, the genus Daedalea, the genus Daedaleopsis, the genus Dichomitus, the genus Dichostereum, the genus Echinodontium, the genus Fibulomyces, the genus Fomitopsis, the genus Fusarium, the genus Ganoderma, the genus Grifola, the genus Hapalopilus, the genus Humicola, the genus Hymenochaete, the genus Hyphoderma, the genus Hyphodontia, the genus Hypochnicium, the genus Inonotus, the genus Irpex, the genus Laurilia, the genus Laxitextum, the genus Lentinus, the genus Lenzites, the genus Lentinula, the genus Leucogyrophana, the genus Lycoperdon, the genus Marasmius, the genus Merulius, the genus Mycoacia, the genus Myrothecium, the genus Paecilomyces the genus Panellus, the genus Penicillium, the genus Peniophora, the genus Perenniporia, the genus Pestalotia, the genus Phanerochaete, the genus Phellinus, the genus Phlebia, the genus Pholiota, the genus Pleurotus, the genus Polyporus, the genus Poda, the genus Punctularia, the genus Pycnoporus, the genus Resinicium, the genus Schizophyllum, the genus Scytinostroma, the genus teccherinum, the genus Trametes, the genus Trichoderma, the genus Tyromyces and the genus Vararia.

In a more preferred embodiment said white-rot fungi are selected from the group consisting of the genus Acanthophysium, the genus Coriolopsis, the genus Clitocybula, the genus Cystostereum, the genus Ganoderma, the genus Paecilomyces, the genus Perenniporia, the genus Phellinus, the genus Phlebia, the genus Pycnoporus, and the genus Trametes.

In yet a more preferred embodiment said white-rot fungi are selected form the group consisting of Acantophysium bisporum MUCL 32213, Coriolopsis polyzona MUCL 38443, Cystostereum murraii MUCL 33747, Ganoderma subamboinense MUCL 38859, Lentinus cladopus MUCL 28678, Lentinula edodes MUCL 29756, Lenzites betulina MUCL 38559, Merulius tremelosus MUCL 38065, Paecilomyces variotii MUCL 21705, Perenniporia medulla-panis MUCL 40050, Perenniporia ochroleuca MUCL 41114, Perenniporia tephropora MUCL 41562, Phanerochaete chrysospodum MUCL 19343, Phanerochaete ericina MUCL 33845, Phellinus rimosus MUCL 38446, Phlebia subserialis MUCL 33724, Polyporus brumalis MUCL 29280, Polyporus ciliatus MUCL 40141, Pycnoporus cinnabarinus MUCL 38520, Pycnoporus coccineus MUCL 38525, Pycnoporus sanguineus MUCL 41625, Trametes versicolor MUCL 38412 and MUCL 28407.

In yet another more preferred embodiment said white-rot fungi are selected from the group consisting of Clitocybula dusenii DSM 11238, Trichoderma harzanium MUCL 29707 and Trichoderma longibrachiatum MUCL 39887.

In a preferred embodiment said white-rot fungi is grown in a media containing malt extract in a concentration ranging from 0.5 to 8 percent by weight to volume.

In another preferred embodiment said white-rot fungi are added to said liquid waste in an encapsulated form, in a matrix consisting of polymers.

In a preferred embodiment said polymers are selected from the group consisting of alginate salts, carrageenan salts, iota-carrageenan salts, maltodextrin, whey protein concentrate (WPC), skimmed milk powder (SMP), dried yeast autolysate (YA), dried yeast extract (YE), corn starch (CS), modified starch (MS), and polyvinylalcohol.

In a preferred embodiment said white-rot fungi, are employed in an immobilized form.

In a more preferred embodiment said white-rot fungi are immobilized on a support selected from the group consisting of stainless steel support, polymer support and wood support.

In another preferred embodiment, the white-rot fungi active agents are employed as raw preparation, as purified enzymes, or in an immobilized form.

In yet another more preferred embodiment, the white-rot fungi active agents are immobilized on a wood support.

In a preferred embodiment an inductor is added to the white-rot fungi culture, preferably after said fungi has reached a significant bio-mass.

In a more preferred embodiment said inductor has an azo anthraquinonic or a stilbenic dye structure. In another more preferred embodiment said inductor has a phenolic, aromatic or metallic structure.

In a preferred embodiment oxygen is added during the incubation of said white-rot fungi in said pretreated liquid waste.

In another preferred embodiment a suitable amount of nutrients are added during the incubation of said white-rot fungi in said pretreated liquid waste, to encourage the regeneration of cell activity of said white-rot fungi.

In a more preferred embodiment the nutrients are added in an amount ranging from 0.5 to 4 percent in weight per volume.

In a preferred embodiment the pH during the incubation of said white-rot fungi in said pretreated liquid waste is ranging from 4 to 9 and the temperature of incubation is ranging from 20 to 45° C.

In a more preferred embodiment the pH during the incubation of said active agents in said pretreated liquid waste is ranging from 2 to 7 and the temperature of incubation is ranging from 20 to 70° C.

In another embodiment the pH during the incubation of said white-rot fungi or active agents thereof in said pretreated liquid waste is ranging from 1 to 9 and the temperature of incubation is ranging from 18 to 70° C.

In a preferred embodiment said white-rot fungi or active agents thereof, are incubated with said pretreated liquid waste for 2 hours to 14 days.

In another preferred embodiment said white-rot fungi or active agents thereof, are incubated with said pretreated liquid waste for 20 minutes to 14 days.

In another embodiment, said fungi or active agents thereof obtainable after step b) of the process are separated.

In another embodiment, the present invention relates to a process, wherein said separated fungi or active agents thereof are reused in the process for treating liquid waste.

In another embodiment, the present invention also relates to the use of fungi or active agents thereof obtainable after step b) of the process for treating liquid waste into a green waste composting process.

Further, the present invention provides a method for immobilising fungal active agents on a support comprising the steps of:
culturing a fungus in a medium,
immersing a support with the supernatant of said fungal culture, and
immobilising the active agents of said fungi on said support, said agents being released in the fungal culture supernatant.

The aspects of this invention and other embodiments are more fully set forth in the following detailed description and the accompanying figures and examples.

### BRIEF DESCRIPTION OF THE FIGURES

FIG. 1 shows the effect of white-rot fungi on the decoloration of NY3 dye, with and without a pre-culture step expressed as a change of absorbance as a function of time.

FIG. 2 shows the effect of oxygen addition on the decoloration of NY3 dye by white-rot fungi, expressed as a change of absorbance as a function of time.

FIG. 3 shows the effect of a fungus immobilized on a support on the decoloration of NY3 dye, expressed as a change of absorbance as a function of time.

FIG. 4 shows the effect of different immobilization supports on effluent decolorization during 8 or 20 days of fungal culture, with ozonolysis as pretreatment.

FIG. 5 represents a wavelength scan of the anthraquinonic dye NY3 during its bio-transformation by white-rot fungi.

FIG. 6 shows the effect of adding different concentrations of malt solution on the decoloration of NY3 dye by white-rot fungi, expressed as a change of absorbance as a function of time.

FIG. 7 shows the decoloration results obtained after treating crude or ozonized-pretreated effluents by white-rot fungi (20 days of culture).

FIG. 8 shows the effect of white-rot fungi treatment on the toxicity of crude or ozonized effluents before or after said treatment.

FIG. 9 shows the mutagenicity of crude effluent, expressed as a ratio rec/pr1 as a function of the concentration of said effluent.

FIG. 10 shows the mutagenicity of ozonised effluent expressed as a ratio rec/pr1 as a function of the concentration of said effluent.

FIG. 11 shows the mutagenicity of crude effluent treated with white-rot fungi, expressed as a ratio rec/pr1 as a function of the concentration of said effluent.

FIG. 12 shows the mutagenicity of ozonised effluent treated with white-rot fungi, expressed as a ratio rec/pr1 as a function of the concentration of said effluent.

FIG. 13 shows the decoiorization results obtained after treating crude or wood adsorption-pretreated effluents by white-rot fungi (8 days of culture).

FIG. 14 shows the effect of laccases treatment on the decolorization of crude and ozonised effluents.

FIG. 15 shows the spectral change during decolorization of NY3 by concentrated laccase added as a solution or after extraction through adsorption on wood.

### DETAILED DESCRIPTION

Several problems are currently observed with respect to the decoloration of dyes of effluents by means of fungi, which restrict the use of the fungi in industrial processes and applications.

One problem consists of the fact that the effluents inhibit fungal growth. As a consequence, the time required for efficient decoloration of effluents is extremely long. For this reason, the fermentation tanks for use in such processes require non-realistic dimensions and such processes are not economically interesting. Another problem consists of the fact that the media used for the fungal growth is not always usable at industrial scale. Another problem consists of the fact that up to now the mean criterion used to determine the efficiency of the fungal process is decoloration. Nevertheless some bacteria were demonstrated as forming toxic as well as carcinogenic compounds after degradation of azoïc dyes. This could lead to a paradoxical situation in which wastewater treated and uncolored could be thrown into the environment while being more toxic than before treatment. The present invention provides a solution to these and other problems, by providing a method for decoloration and detoxification of liquid waste using fungi.

According to a preferred embodiment, the present invention relates to a process for treating liquid waste such as liquid waste from dye industries, compost effluent or agricultural effluent.

Said process permits the treatment of dyes-polluted liquid waste, wherein the dyes can be textile dyes, acid dyes, basic dyes, direct dyes, reactive dyes, disperse dyes, and mixtures thereof. In a more preferred embodiment said liquid waste is contaminated with azo dyes, anthraquinones dyes and/or stilbenic dyes.

In yet another more preferred embodiment said liquid waste is contaminated with humic acids.

The first step of said process consists of a pretreatment step of the liquid waste. Said pretreatment may be physical and/or chemical, according to processes known in the art. In a preferred embodiment, said pretreatment is selected from the group consisting of ozone treatment, adsorption process, including adsorption of the waste on biodegradable supports, membrane filtration such as micro or nanofiltration, osmose ion exchange, electrolysis process, sodium borohydride process, electrochemical treatments such as cathodic and anodic process, direct and indirect electrochemical oxidation, electrochemical in situ synthesis of oxidizing agents, electrodialysis, electromembrane processes, and electrochemical pre-oxidation, electrochemical ion exchange, electroflocculation, photochemical degradation, chemical degradation, Fenton's oxidation process.

According to a more preferred embodiment, said pretreatment is an ozone treatment. As used herein “ozon treatment” is also referred to as “ozonolysis” or “ozonisation”.

The first pretreatment step may be performed for 10 minutes to 72 hours according to the process used. More preferably, first pretreatment step may be performed for 0.5 to 10 hours according to the process used. When the pretreatment is an ozone treatment, said liquid waste is preferably pretreated for 1 to 3 hours and more preferably for 1.5 hour of decoloration.

According to another more preferred embodiment, said pretreatment is an adsorption process, and preferably comprises adsorption of the waste on a biodegradable support, preferably a polymer support. The most common adsorption supports are activated charcoal, silica gel, bauxite, peat, wood, cellulose derivatives or ions exchange resin. In a most preferred embodiment of this invention, the adsorption support used as pretreatment is comprised of wood shavings. Such wood shavings can be collected as an industrial by-product for example in saw-mills and in furniture industry. Advantageously such wood shavings are inexpensive. Suitable supports can be constituted of different woods including but not limited to Betula sp., Fagus sp., Quercus sp. Pinus sp., Picea sp. Acer sp. Tilia sp., Populus sp., Castanea sp., Fraxinus sp., Juglans sp., Platanus sp. Teck sp., Meranti sp. or Cocos sp. The wood shavings are dimensioned from sawdust to big wood shavings.

Preferably, said wood shavings are added to liquid waste to be treated in the range of 0.1 to 100 g per liter. The time required for the treatment of the waste can vary between 10 minutes and 3 days.

This first step allows a sensible decoloration of said liquid waste, from 150000 color units (APHA) to 80000 APHA in the case of ozone pretreatment and to 75000 APHA in the case of adsorption on a wood support. Said first step also permits a diminution on average of 10% of the chemical oxygen demand (COD).

The second step of said process consists of the treatment of said pretreated liquid with fungi or active agents thereof. According to a preferred embodiment the fungi are white-rot fungi.

The white-rot fungi can be selected from the group comprising the genus Acanthophysium, the genus Aleurobotrys, the genus Aleurodiscus, the genus Amphinema, the genus Amylostereum, the genus Armillaria, the genus Aspergillus, the genus Asterostroma, the genus Auricularia, the genus Botryobasidium, the genus Botryohypochnus, the genus Calocera, the genus Chaetomium, the genus Cladorrhinum, the genus Clitocybula, the genus Columnocystis, the genus Coriolopsis, the genus Cystostereum, the genus Daedalea, the genus Daedaleopsis, the genus Dichomitus, the genus Dichostereum, the genus Echinodontium, the genus Fibulomyces, the genus Fomitopsis, the genus Fusarium, the genus Ganoderma, the genus Grifola, the genus Hapalopilus, the genus Humicola, the genus Hymenochaete, the genus Hyphoderma, the genus Hyphodontia, the genus Hypochnicium, the genus Inonotus, the genus Irpex, the genus Laurilia, the genus Laxitextum, the genus Lentinus, the genus Lenzites, the genus Lentinula, the genus Leucogyrophana, the genus Lycoperdon, the genus Marasmius, the genus Merulius, the genus Mycoacia, the genus Myrothecium, the genus Paecilomyces the genus Panellus, the genus Penicillium, the genus Peniophora, the genus Perenniporia, the genus Pestalotia, the genus Phanerochaete, the genus Phellinus, the genus Phlebia, the genus Pholiota, the genus Pleurotus, the genus Polyporus, the genus Poria, the genus Punctularia, the genus Pycnoporus, the genus Resinicium, the genus Schizophyllum, the genus Scytinostroma, the genus Steccherinum, the genus Trametes, the genus Trichoderma, the genus Tyromyces and the genus Vararia. Table 1 in example 3, lists several white-rot fungi strains, which have been successfully used, according to said process.

According to a preferred embodiment, said white-rot fungi belong to the genus Acantophysium, the genus Chaetomium, the genus Clitocybula, the genus Coriolopsis, the genus Cystostereum, the genus Ganoderma, the genus Lentinus, the genus Lentinula, the genus Lenzites, the genus Merulius, the genus Paecilomyces, the genus Perenniporia, the genus Phanerochaete, the genus Phellinus, the genus Phlebia, the genus Polyporus, the genus Pycnoporus and the genus Trametes. More preferably said white-rot fungi belong to the genus Acanthophysium, the genus Coriolopsis, the genus Clitocybula, the genus Cystostereum, the genus Ganoderma, the genus Paecilomyces, the genus Perenniporia, the genus Phellinus, the genus Phlebia, the genus Pycnoporus and the genus Trametes.

According to a more preferred embodiment, said white-rot fungi are selected form the group consisting of Acantophysium bisporum MUCL 32213, Coriolopsis polyzona MUCL 38443, Cystostereum murraii MUCL 33747, Ganoderma subamboinense MUCL 38859, Lentinus cladopus MUCL 28678, Lentinula edodes MUCL 29756, Lenzites betulina MUCL 38559, Merulius tremelosus MUCL 38065, Paecilomyces variotii MUCL 21705, Perenniporia medulla-panis MUCL 40050, Perenniporia ochroleuca MUCL 41114, Perenniporia tephropora MUCL 41562, Phanerochaete chrysosporium MUCL 19343, Phanerochaete ericina MUCL 33845, Phellinus rimosus MUCL 38446, Phlebia subserialis MUCL 33724, Polyporus brumalis MUCL 29280, Polyporus ciliatus MUCL 40141, Pycnoporus cinnabarinus MUCL 38520, Pycnoporus coccineus MUCL 38525, Pycnoporus sanguineus MUCL 41625 and MUCL 41582, Trametes versicolor MUCL 38412 and MUCL 28407. Yet more preferably said white-rot fungi are selected from the group consisting of Acantophysium bisporum MUCL 32213, Coriolopsis polyzona MUCL 38443, Cystostereum murraii MUCL 33747, Paecilomyces variotii MUCL 21705, Perenniporia medulla-panis MUCL 40050, Perenniporia ochroleuca MUCL 41114, Perenniporia tephropora MUCL 41562, Phellinus rimosus MUCL 38446, Phlebia subserialis MUCL 33724, Pycnoporus coccineus MUCL 38525, Pycnoporus sanguineus MUCL 41625 and Trametes versicolor MUCL 38412.

According to another more preferred embodiment, said white-rot fungi are selected from the group consisting of Clitocybula dusenii DSM 11238, Trichoderma harzanium MUCL 29707 and Trichoderma longibrachiatum MUCL 39887.

According to the invention the white-rot fungi are cultured using techniques known in the art. These fungi are preferably grown in rich media comprising a carbon source, a nitrogen source and mineral salts. Said white-rot fungi can also be grown on wood such as wood shavings, which constitute an excellent source of nutrients. They can be incubated at temperatures ranging from 20 to 45° C. and at a pH ranging from 4 to 9, under shaking conditions or not. According to a preferred embodiment, said white-rot fungi are grown in a medium containing malt extract in a concentration ranging from 0.5 to 8% (w/v). In a more preferred embodiment said, white-rot fungi are grown in a 2% malt medium.

During said second step, active agents isolated from said white-rot fungi can also be used to treat said pretreated liquid waste. The term “active agents” as used herein, encompass white-rot fungi crude cell extracts, semi-purified cell extracts, concentrated cell extracts, isolated or purified agents, such as enzymes or a mixture of enzymes. According to a preferred embodiment said active agents are enzymes such as tyrosinase, hydrolytic enzymes such as hydrolases, cellulolytic enzymes such as cellulase or xylanases, or ligninolytic enzymes such as extracellular oxidases and peroxidases, lacasses, lignin- or Mn peroxidases, cellobiose deshydrogenase, produced by said white-rot fungi. In another preferred embodiment, the white-rot fungi active agents comprise hydrolytic, cellulolytic or ligninolytic enzymes. More preferably said active agents are selected from the group consisting of laccases, lignin peroxidases and manganese peroxidases, or mixtures thereof. According to a yet more preferred embodiment said active agents are laccase enzymes. In yet another preferred embodiment, said active agents may also comprise small molecules such as organic acids, aromatic active compounds or mixture thereof.

In another preferred embodiment, the white-rot fungi active agents are employed as raw preparation, as purified enzymes, or in an immobilized form. Preferably, according to yet another more preferred embodiment, the white-rot fungi active agents are immobilized on a wood support, e.g. on wood shavings.

During said second step, said white-rot fungi may be added to said pretreated liquid waste as a pure, mixed, or enriched culture as cells, mycelium fragments, spores, pre-culture inoculum, culture broth, or as supernatant. According to another embodiment, said white-rot fungi can be added to said pretreated liquid, either singly, or in combination with other microorganisms such as fungi or bacteria.

According to yet another embodiment, the white-rot fungi to be added to said pretreated liquid waste may be encapsulated in a matrix consisting of polymers. In a preferred embodiment said polymers consist of biodegradable, natural, non-toxic polymers. More preferably said polymers are selected from the group consisting of alginate salts, kappa-carrageenan salts, iota-carrageenan salts, maltodextrin, whey protein concentrate (WPC), skimmed milk powder (SMP), dried yeast autolysate (YA), dried yeast extract (YE), corn starch (CS), modified starch (MS), and polyvinylalcohol. Yet more preferably said polymers are selected from the group consisting of alginate salts, kappa-carrageenan salts and iota-carrageenan salts. Other suitable polymers comprise cellulose or polypropylene. In another embodiment, also the active agents of said fungi to be added to said pretreated liquid waste may be encapsulated in a matrix consisting of polymers. Said encapsulated form of the fungi or the active agents thereof is also meant for conservation of the fungi or the active agents thereof and can be inoculated in pre-culture. Thus, in another preferred embodiment said white-rot fungi or the active agents thereof are conserved and inoculated in pre-culture in an encapsulated form, i.e. in a matrix consisting of polymers.

According to another embodiment, during said second step, said white-rot fungi could be further immobilized. More preferably, said white-rot fungi are immobilized on a support such as stainless steel support or support made of bio-beads such as those usually used for the biological cleaning of fish tanks, for example DUPLA Biokaskade or Minikaskade bio-beads. These bio-beads are usually made of polymer such as polypropylene. Said white-rot fungi can also be immobilized on wood, more particularly on wood shavings. Said white-rot fungi can also be immobilized on air filters, e.g. on Vileda Dunstfilters. Examples of suitable matrices include but are not limited to stainless steel, or synthetic polymer such as polypropylene. According to a preferred embodiment, said white-rot fungi are preferably immobilized on a stainless steel support, which is preferably in a mesh, a web form, or an interwoven or entangled mass of stainless steel strands.

The white-rot fungi active agents, such as the laccases for example, may also be used in immobilized form using the immobilization techniques mentioned below.

According to another embodiment, in order to improve the efficiency of the white-rot fungi treatment of said pretreated liquid waste, it is also possible to add an inductor to the white-rot fungi culture media preferably after said fungi has reached a significant bio-mass. The inductor will preferably have an azo, an anthraquinonic or a stilbenic like structure. Non limiting example of inductors are shown in example 4. Other inductors such as ferulic acid or xylidine can also be used. In another more preferred embodiment said inductor has a phenolic, aromatic or metallic structure. When the inductor is added at the beginning of the fungus growth, the bio-transformation of the dye happens but a latent period is observed.

During the second step, the white-rot fungi or active agents thereof are incubated with said pretreated liquid waste, which can be provided in a continual or sequential way and may be collected at the end of the treatment also in a continual of sequential way. According to a preferred embodiment, said pretreated liquid waste is first diluted from 2 to 10 times before treatment with white-rot fungi or active agents thereof. Alternatively, said pretreated liquid waste can also be used undiluted, preferably when the liquid waste is to be treated with active agents.

According to another embodiment, oxygen may be added during the second step treatment i.e. during the incubation of said white-rot fungi in said pretreated liquid waste. Said oxygen addition will further improve the process's efficiency, by improving the development and the survival rate of said white-rot fungi. Moreover, the oxygen plays a major role in the oxidative fungal ligninolytic mechanisms, which is directly involved in the degradation of various compounds including dyes.

According to yet another embodiment, a suitable amount of nutrients can further be added during the second step i.e. during the incubation of said white-rot fungi in said pretreated liquid waste. This nutrient addition will improve the regeneration of cell activity of said white-rot fungi. Non limiting examples of nutrients are malt extract, beetroot pulp residues, molasses, bagasses and other nutrient sources containing sugars. In a preferred embodiment, the nutrients are added in an amount ranging from 0.5 to 4 percent (w/v).

According to a preferred embodiment, the treatment of said pretreated liquid waste with said white-rot fungi, can be performed at a pH ranging from 4 to 9 and at a temperature ranging from 20 to 45° C. The incubation time is preferably ranging from 3 to 14 days.

According to another preferred embodiment, the treatment of said pretreated liquid waste with said white-rot fungi active agents, can be performed at a pH ranging from 2 to 7 and at a temperature ranging from 20 to 70° C. The incubation time will preferably range from 2 to 24 hours.

In a more preferred embodiment the pH during the incubation of said white-rot fungi or active agents thereof in said pretreated liquid waste is ranging from 1 to 9 and the temperature of incubation is ranging from 18 to 70° C. In another preferred embodiment said white-rot fungi or active agents thereof, are incubated with said pretreated liquid waste for 20 minutes to 14 days.

The present invention therefore relates to a process wherein said pretreatment in combination with a treatment with white-rot fungi or active agents thereof are effective in removing from 28.4 percent to 99.5 percent of the color of said liquid waste as measured by the change in optical density before and after pretreatment and incubation with said white-rot fungi or active agents thereof.

The present invention also relates to a process, wherein said pretreatment in combination with a treatment with white-rot fungi or active agents thereof are effective in detoxifying said liquid waste as measured by the toxicity of said liquid waste on human cells, before and after pretreatment and incubation with said white-rot fungi.

In another embodiment, said fungi or active agents thereof obtainable after step b) of the process are separated. In another embodiment, the present invention relates to a process, wherein said separated fungi or active agents thereof are reused in the process for treating liquid waste.

In another embodiment, the present invention also relates to the use of fungi or active agents thereof obtainable after step b) of the process for treating liquid waste into a green waste composting process. In general, a green waste composting process is generally very slow because of the presence of quantities of low degradable lignocellulotic residues, phenolic compounds and humic acids. The fungi that are used in the process for treating liquid waste can be further valorized in green waste composting processes. These fungi, since they produce lignolytic enzymes, enable to improve the green waste composting process. They can be added in the primarily phase of the composting to initiate the degradation of compounds and facilitate the following bacterial transformations. In this case fungal biomass will be killed during the thermophilic phase of composting and presents no risk for the environment. They can also be used in the final maturation step of composting, but in this case, only non-pathogenic fungal strains can be used. Strains comprised herein here have been selected to be GRAS (generally recognized as safe). An example of non-pathogenic strain is Pycnoporus sanguineus MUCL 41582.

In another preferred embodiment, fungal biomass which has been grown on wood chips as immobilization support is transferred after water treatment into a green waste composting process to improve this latter process. The wood chips have the advantage over the other supports to be biodegradable and the fungal biomass produced on the wooden support can be directly transferred into green waste composting plants, without the need for a complicated step to separate the biomass from the support.

The present invention provides an easy and inexpensive method for immobilizing said active agents on a support. Further, the use of the active agents, preferably enzymes, in an immobilized form enables to obtain said enzymes in a concentrated form, without having to resort to other enzyme concentration techniques such as dialysis, ultrafiltration or the use of columns. The method for immobilising fungi active agents on a support comprises the steps of:
culturing a fungus in a medium,
immersing a support with the supernatant of said fungal culture, and
immobilising the active agents of said fungi on said support, said agents being released in the fungal culture supernatant.

In a preferred embodiment, said method comprises the immobilisation of fungi active agents on a wood support, and consists of preparing a fungal culture, immersion of wood shavings or sawdust into the extracellular fluids of the fungal culture and immobilizing the enzymes released into the extracellular fluids of the fungal culture on the wood shavings. According to a yet more preferred embodiment said wood can be added to the culture supernatant in quantity comprised between 0.1 and 100 g per liter of growth medium, during 1 second to 24 hours.

The present invention describes a process, which is sustainable. As used herein, the term “sustainable” relates to the fact that the fungal biomass used in the process for treatment of liquid waste can be re-used for the same process of liquid waste treatment, but may be also further re-used in other applications, such as for the improvement of green waste composting processes. Furthermore, the process is environmental friendly.

The present invention will be further described hereunder by way of non-limiting examples.

### EXAMPLES

### Example 1

In a preferred embodiment of the process according to the invention, the pretreatment step in said process is an ozonisation.

The ozone is produced from pure oxygen using an ozone generator of type OZONIA ZF10AT which can produce 10 to 30 kg of ozone per hour and can treat 800 m³ of industrial liquid waste per day. The concentration in ozone produced is 10% w/w (O₃/O₂), the quality is controlled by spectrophotometry at 258 nm by passing the gas phase through a flow cell. The ozonisation of liquid waste is performed in a 50 m³ vertical reaction tank. A radial diffuser allows the injection of the gas in said liquid waste through a venturi tube. The flow rate of the gas varies from 11 to 22 m³ per hour. The liquid waste to be treated by ozonisation is usually at pH 5 (±0.5) and at a temperature of 30 to 35° C. The ideal incubation time is 1.5 hours, which is obtained by recycling said liquid waste through the tank. This ozone treatment allows a decrease of the color in said liquid waste from 150000 color units (APHA) to 80000 color units (APHA) and also a diminution of the COD on average of 10%.

APHA is an abbreviation for “American Public Health Association”, which publishes a collection of test procedures for water and wastewater. It describes the determination of the color standard in Hazen units, wherein 1 mg/l Pt equals one Hazen. The stock solution is prepared as follows: Dissolve 2.49 g K₂PtCl₆ and 2.02 g CoCl₂.6H₂O in 200 ml of concentrated pure HCl (d=1.19) and dilute to 1 liter with distilled water. The absorbance of this solution at 455 nm represents 1000 Hazen. This method was elaborated to measure the color of surface water, which generally absorb light in this region (455 nm). In the case of colored wastewater, we use a spectrophotometric integrative method (SIM), and the results are converted in color units (APHA). This method is able to measure coloration of the water in the visible spectrum. In practice, the absorbance of the sample is measured in the visible region (from 380 to 740 nm). The integration of the curve absorbance/wavelength gives a numerical result in area units. To convert this result in color units (APHA), 5 dilutions of the stock solution of the standard (containing Pt) described above are measured by the two methods Hazen and SIM. A graph area/hazen units is constructed for the standard. A conversion factor is calculated, and the result obtained for the sample can be converted through the conversion factor and expressed in color units (APHA).

The chemical oxygen demand (COD) is the amount of oxygen required to oxidize by chemical means organic carbon compounds completely to CO₂ and H₂O. In practice, organic matter in water is oxidized by K2Cr2O7 under rather stringent conditions. The amount of dichromate oxygen used is determined and expressed as COD. The method used is a normalized method (NFT 90.101 or DIN 38 409-H41-1) based on a photometric determination of chromium (III) concentration after 2 hours of oxidation with potassium dichromate/sulfuric acid/silver sulfate at 148° C. A 620 nm filter is used.

### Example 2

A non-exhaustive list of suitable pretreatment according to the invention is given hereunder.

Adsorption:

The most commons adsorption supports are activated charcoal, silica gel, bauxite, peat, wood, cellulose derivatives, ions exchange resin.

For illustrating the pretreatment of adsorption on wood, the following example is given. In this example, wood shavings are constituted by pieces of about 4 square centimeters from Fagus sylvatica, obtained as a by-product from a furniture industry. Said wood shaving are added in a concentration of 3 g per liter and incubated during 24 hours. The color of a dye industry effluent was measured before and after this pretreatment and a decrease from initial 105 000 to 72 000 color units (APHA) was measured. This result is nearly the same as obtained through ozonolysis, but the costs related to this latter method are considerably reduced.

Membrane Filtration:

Ultrafiltration, micro or nanofiltration: use a combination of activated carbon adsorption followed by a membrane separation (Sandoz). The activated charcoal adsorbs the most resistant elements which have a low molecular weight and the membranes such as nanofiltration membranes stop the elements with a molecular weight higher than 1000.

Electrolysis:

Electrolysis is a process, which was initially reserved to liquid contaminates with metals, however, this process permits a decrease of the coloration of liquid waste of about 90 to 95%.

Process Using Sodium Borohydride (Type Reading, UK):

This process consists of first adjusting the pH of the liquid waste to pH 5.5 and subsequently adding to said liquid waste, successively, a solution of sulfuric acid, a flocculent (Metafloc 137), a solution of sodium bisulfate, a solution of sodium borohydride in a basic solution (Morton). This process allows the decrease of the COD on average of 33% and eliminates 85% of the amount of copper and decreases the color by about 90%.

Electrochemical Treatments:

In electrochemical treatments, oxidation is achieved by mean of electrodes, where a determined difference of potential is applied, dipped in the effluent to treat. Efficiency of the method is a function of several parameters difference of potential, nature of the electrodes, pH. On this principle, several different processes have been developed as cathodic and anodic processes, direct and indirect electrochemical oxidation, electrochemical in situ synthesis of oxidizing agents, electrodialysis, electromembrane processes, and electrochemical ion exchange.

Electroflocculation:

Electroflocculation is the combination of an oxidation, a flocculation and a flotation and involves the electrolytic addition of coagulating metal ions directly from sacrificial electrodes.

These ions coagulate with pollutants in the water, in a similar manner to the addition of coagulating chemicals such as aluminum chloride and ferric chloride, and allow the easier removal of the pollutants. The process involves the application of an electric current to sacrificial electrodes, usually aluminum, inside a processing tank. The reactions at the anode and cathode respectively are typically generating aluminum ions as a coagulating agent as well as gas bubbles. The well-known properties of the aluminum ions as a coagulating agent cause them to combine with the pollutants. The gas bubbles generated can capture the coagulated agglomerates, resulting in most of the pollutant being floated to the surface.

Photochemical Degradation:

Permits the transformation of E-isomers to Z-isomers using UV-Vis irradiation.

Chemical Degradation:

Usually using oxidizing agents. The most common oxidizing agents are hypochlorite, chlorine gas chlorine dioxide, hydrogen peroxide, ozone, and potassium permanganate. Chlorine based oxidizing agents are particularly efficient on monoazo dyes and anionic anthraquinonic dyes.

Fenton's Oxidation Process:

In the presence of a catalyst, a hydrogen peroxide solution forms hydroxyl radicals (OH) of strong oxidizing power or nascent oxygen (O). This hydroxyl radical, having powerful oxidizing power, can oxidize most organic substances including dechlorinating organic chlorine compounds. In liquid waste treatment, organic substances are decomposed by mixing waste water with hydrogen peroxide and iron catalyst. Then liquid waste is neutralized. This process can decompose bio-persistent colored substances.

### Example 3

A non-exhaustive list of fungi tested during the process according to the invention is shown in table 1. These fungi are deposited in the fungal library MUCL (Mycotheque de l'Universite catholique de Louvain).

TABLE 1

| Genus | Species | N. MUCL |
|---|---|---|
| Acanthophysium | bisporum | 32213 |
| Acanthophysium | cerussatum | 32645 |
| Acanthophysium | lividocaeruleum | 33688 |
| Aleurobotrys | botryosus | 32323 |
| Aleurodiscus | aurantius | 33921 |
| Aleurodiscus | gabonicus | 32433 |
| Aleurodiscus | wakefieldiae | 34807 |
| Amphinema | byssoides | 32977 |
| Amylostereum | areolatum | 32874 |
| Amylostereum | chailletti | 32912 |
| Amylostereum | laevigatum | 33857 |
| Armillaria | gallica | 31339 |
| Aspergillus | niger | 19001 |
| Asterostroma | cervicolor | 38354 |
| Asterostroma | laxum | 38356 |
| Asterostroma | ochroleucum | 38358 |
| Auricularia | auricula | 28689 |
| Auricularia | auricula | 38073 |
| Auricularia | cornea | 28966 |
| Auricularia | fuscosuccinea | 28965 |
| Auricularia | polytricha | 30975 |
| Auricularia | polytricha | 38067 |
| Botryobasidium | candicans | 33808 |
| Botryobasidium | sphaericosporum | 32749 |
| Botryobasidium | sphaericosporum | 32750 |
| Botryohypochnus | isabellinus | 33809 |
| Calocera | viscosa | 31690 |
| Chaetomium | brasiliense | 19261 |
| Chaetomium | globosum | 9597 |
| Chaetomium | globosum var. griseum | 39527 |
| Chaetomium | pachypodioides | 9586 |
| Cladorrhinum | foecundissimum | 4060 |
| Clitocybula | dusenii | DSM 11238 |
| Collybia | peronata | 20939 |
| Collybia | reinakeana | 38064 |
| Columnocystis | abietina | 33928 |
| Coriolopsis | polyzona | 38443 |
| Corticium | meridioroseum | 34729 |
| Cystostereum | murraïi | 33747 |
| Daedalea | quercina | 11661 |
| Daedalea | quercina | 30382 |
| Daedaleopsis | confragosa | 29566 |
| Dendrophora | albobadia | 33710 |
| Dichomitus | leucoplacus | 41472 |
| Dichostereum | durum | 32558 |
| Dichostereum | effuscatum | 33642 |
| Dichostereum | granulosum | 33644 |
| Dichostereum | peniophoroides | 32336 |
| Dichostereum | sordulentum | 32712 |
| Dichostereum | effuscatum | 32221 |
| Dichostereum | orientale | 32644 |
| Dichostereum | pallescens | 32640 |
| Dichostereum | ramulosum | 32279 |
| Dichostereum | rhodosporum | 32191 |
| Dichostereum | sordulentum | 32167 |
| Echinodontium | tinctorium | 1005 |
| Fibulomyces | septentrionalis | 34891 |
| Fomitopsis | rosea | 40102 |
| Fusarium | annulatum | 8059 |
| Fusarium | concolor | 797 |
| Fusarium | incarnatum | 38815 |
| Fusarium | oxysporum | 1064 |
| Fusarium | reticulatum | 19032 |
| Ganoderma | carnosum | 39430 |
| Ganoderma | dejongii | 39643 |
| Ganoderma | oerstedii | 38857 |
| Ganoderma | subamboinense | 38859 |
| Grifola | frondosa | 31544 |
| Hapalopilus | rutilans | 28390 |
| Humicola | brunnea | 8355 |
| Humicola | fuscoatra | 8799 |
| Humicola | nigrescens | 14437 |
| Humicola | nigrescens | 21866 |
| Humicola | parvispora | 19494 |
| Humicola | nigrescens | 7913 |
| Hymenochaete | boidinii | 32028 |
| Hymenochaete | cruenta | 38613 |
| Hymenochaete | rubiginosa | 31546 |
| Hymenochaete | separata | 32762 |
| Hymenochaete | tabacina | 28221 |
| Hymenochaete | pinnatifida | 32735 |
| Hyphoderma | deviatum | 32102 |
| Hyphoderma | litschaueri | 33820 |
| Hyphoderma | mutatum | 32950 |
| Hyphoderma | puberum | 38042 |
| Hyphoderma | setigerum | 38043 |
| Hyphoderma | variolosum | 32509 |
| Hyphodontia | alutaria | 34734 |
| Hypochnicium | vellereum | 34735 |
| Hypochnicium | eichleri | 32105 |
| Hypochnicium | punctulatum | 33699 |
| Inonotus | hispidus | 35148 |
| Inonotus | leporinus | 40107 |
| Irpex | vellereus | 32181 |
| Irpex | lacteus | 31500 |
| Laurilia | sulcata | 40113 |
| Laxitextum | bicolor | 32182 |
| Laxitextum | bicolor | 33705 |
| Lentinula | edodes | 29756 |
| Lentinus | boryanus | 30973 |
| Lentinus | cladopus | 28678 |
| Lentinus | lepideus | 40109 |
| Lentinus | tigrinus | 28826 |
| Lenzites | betulina | 38552 |
| Lenzites | betulina | 38559 |
| Leucogyrophana | pinastri | 30922 |
| Leucogyrophana | pinastri | 34739 |
| Leucogyrophana | pinastri | 39391 |
| Lycoperdon | foetidum | 28389 |
| Marasmius | androsaceus | 31691 |
| Marasmius | androsaceus | 35155 |
| Marasmius | oreades | 28591 |
| Merulius | tremellosus | 38065 |
| Mycoacia | nothofagi | 33992 |
| Myrothecium | verrucaria | 19018 |
| Paecilomyces | cremeoroseus | 9652 |
| Paecilomyces | marquandii | 4138 |
| Paecilomyces | inflatus | 8231 |
| Paecilomyces | inflatus | 34987 |
| Paecilomyces | variotii | 21705 |
| Paecilomyces | variotii | 28553 |
| Paecilomyces | variotii | 28975 |
| Paecilomyces | variotii | 30859 |
| Paecilomyces | victoriae | 9651 |
| Paecilomyces | marquandii | 18884 |
| Panellus | serotinus | 31030 |
| Penicillium | expansum | 38789 |
| Peniophora | aurantiaca | 33768 |
| Peniophora | fissilis | 32709 |
| Peniophora | gigantea | 1001 |
| Peniophora | incarnata | 30546 |
| Peniophora | lycii | 35220 |
| Peniophora | piceae | 31774 |
| Peniophora | polygonia | 32112 |
| Peniophora | proxima | 33999 |
| Perenniporia | ellisiana | 39555 |
| Perenniporia | formosana | 38828 |
| Perenniporia | fraxinea | 35180 |
| Perenniporia | fraxinea | 39556 |
| Perenniporia | fraxinea | 41509 |
| Perenniporia | fraxinophila | 39561 |
| Perenniporia | fraxinophila | 39822 |
| Perenniporia | maackiae | 38881 |
| Perenniporia | martius | 40486 |
| Perenniporia | medulla-panis | 40050 |
| Perenniporia | medulla-panis | 38746 |
| Perenniporia | narymica | 39551 |
| Perenniporia | ochroleuca | 39819 |
| Perenniporia | ochroleuca | 41114 |
| Perenniporia | ohiensis | 38827 |
| Perenniporia | ohiensis | 39727 |
| Perenniporia | podocarpi | 40483 |
| Perenniporia | subacida | 39553 |
| Perenniporia | subacida | 39820 |
| Perenniporia | tephropora | 41562 |
| Pestalotia | oxyanthi | 35070 |
| Pestalotia | populi-nigrae | 31398 |
| Pestalotia | subcuticuralis | 7966 |
| Pestalotia | subsessilis | 38335 |
| Phanerochaete | chrysosporium | 19343 |
| Phanerochaete | Chrysosporum | 31762 |
| Phanerochaete | chrysosporium | 38489 |
| Phanerochaete | ravenelii | 33671 |
| Phanerochaete | salmonicolor | 30464 |
| Phanerochaete | sordida | 34000 |
| Phanerochaete | sanguinea | 30740 |
| Phanerochaete | tamariciphila | 39084 |
| Phanerochaete | tuberculata | 33892 |
| Phanerochaete | ericina | 33845 |
| Phellinus | ferreus | 28239 |
| Phellinus | hartigii | 31400 |
| Phellinus | jezoënsis | 38884 |
| Phellinus | laevigatus | 1006 |
| Phellinus | rimosus | 38446 |
| Phellinus | tuberculosus | 35098 |
| Phellinus | alni | 38882 |
| Phellinus | contiguus | 30799 |
| Phellinus | rimosus | 38446 |
| Phlebia | livida | 33615 |
| Phlebia | ludoviciana | 34701 |
| Phlebia | radiata | 30503 |
| Phlebia | radiata | 39535 |
| Phlebia | subcalcea | 32243 |
| Phlebia | subochraceus | 33903 |
| Phlebia | subserialis | 33724 |
| Pholiota | adiposa | 7900 |
| Pholiota | lenta | 28253 |
| Pholiota | nameko | 31614 |
| Pleurotus | calyptratus | 28909 |
| Pleurotus | columbinus | 38096 |
| Pleurotus | cornupiae | 31683 |
| Pleurotus | eous | 38684 |
| Pleurotus | eryngii | 31538 |
| Pleurotus | flabellatus | 38085 |
| Pleurotus | floridanus | 38055 |
| Pleurotus | pulmonarius | 34667 |
| Pleurotus | sajor-caju | 38076 |
| Polyporus | umbellatus | 31707 |
| Polyporus | arcularius | 40124 |
| Polyporus | brumalis | 40131 |
| Polyporus | ciliatus | 30563 |
| Polyporus | grammocephalus | 39575 |
| Polyporus | meridionalis | 40149 |
| Polyporus | dictyopus | 40147 |
| Polyporus | tenuiculus | 40151 |
| Polyporus | tubaeformis | 39667 |
| Polyporus | tuberaster | 39586 |
| Polyporus | brumalis | 29280 |
| Polyporus | ciliatus | 40141 |
| Poria | placenta | 30853 |
| Punctularia | tuberculosa | 33849 |
| Pycnoporus | cinnabarinus | 38518 |
| Pycnoporus | cinnabarinus | 38520 |
| Pycnoporus | cinnabarinus | 38607 |
| Pycnoporus | cinnabarinus | 38620 |
| Pycnoporus | coccineus | 38524 |
| Pycnoporus | coccineus | 38525 |
| Pycnoporus | coccineus | 38527 |
| Pycnoporus | sanguineus | 28499 |
| Pycnoporus | sanguineus | 30513 |
| Pycnoporus | sanguineus | 38530 |
| Pycnoporus | sanguineus | 38531 |
| Pycnoporus | sanguineus | 39259 |
| Pycnoporus | sanguineus | 41582 |
| Pycnoporus | sanguineus | 41594 |
| Pycnoporus | sanguineus | 41625 |
| Pycnoporus | sanguineus | 41627 |
| Pycnoporus | sanguineus | 41660 |
| Pycnoporus | puniceus | 41780 |
| Resinicium | bicolor | 31716 |
| Schizophyllum | commune | 31016 |
| Scytinostroma | mediterraneense | 34754 |
| Scytinostroma | renisporum | 32568 |
| Steccherinum | rhois | 32827 |
| Trametes | gibbosa | 29020 |
| Trametes | zonatella | 40172 |
| Trametes | varians | 40171 |
| Trametes | versicolor | 28407 |
| Trametes | versicolor | 38412 |
| Trichoderma | longibrachiatum | 29753 |
| Trichoderma | harzianum | 29707 |
| Trichoderma | longibrachiatum | 39887 |
| Tyromyces | kmetii | 39628 |
| Vararia | breviphysa | 32576 |

### Example 4

Examples of chemical structures of inductors useful in said process according to the invention and their sterilization protocol are given hereunder.

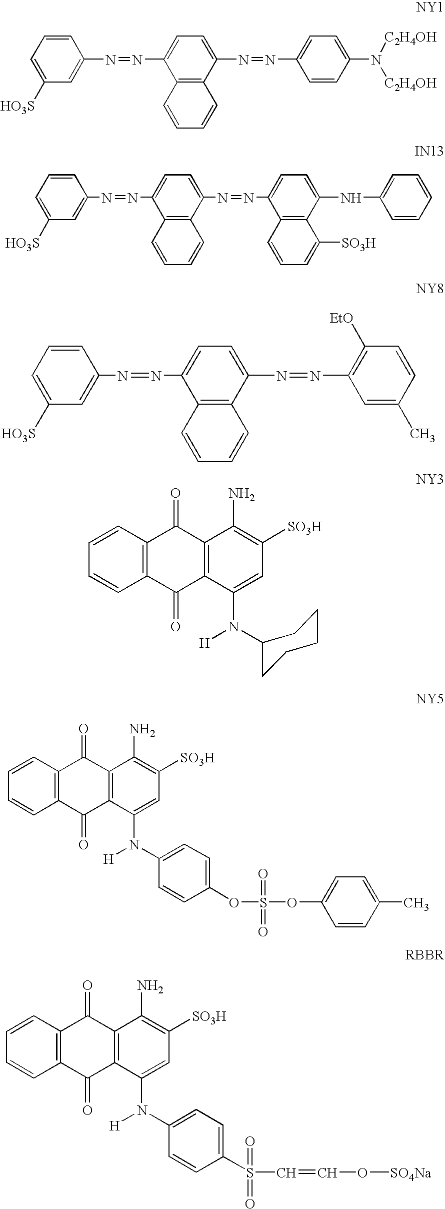

Prior to being added to the fungal culture, the inductors can be sterilized by tyndallisation which consists of a sterilization process at low temperature, which has the advantage of preserving the inductor from being destroyed. The process consists of measuring the suitable quantity of inductor, adding the inductor to a glass tube, heating the tube for 1 hour at 60° C. in a water bath, then let is cool for 24 hours, repeating the heating and cooling steps for 3 to 5 times.

In an example, the inductors NY3, NY5 and RBBR were added to a fungal culture of Pycnoporus sanguineus MUCL 41582 after 2 days of pre-culture. Laccase activity was measured after 5 days of incubation of the culture with the inductors. Results are indicated in the below-given Table 2 and show clearly that laccase activity is enhanced when the fungus is cultured in the presence of inductors. A more than 20 fold increase was observed in the case of the addition of the inductor NY5.

TABLE 2

| Inductors | Without inductor | NY3 | NY5 | RBBR |
|---|---|---|---|---|
| Enzymatic activity (nmol/ml) | 0.41 | 3.87 | 11.60 | 5.40 |

### Example 5

Examples of media and inoculation procedures for the white-rot fungi are given hereunder.

Malt medium (2%) (ML2): White-rot fungi are best grown in a malt extract medium, which consists of a solution of 2% (w/v) of malt extract in water. The medium is sterilized by autoclaving for 18 min, at 120° C., at a pressure of 1.2 bars.

Preparation of inoculum using mycelium fragments from a pre-culture of the fungus on a malt-agar media (2%). The medium is prepared with 2% w/v malt extract and 1.5% w/v agar in water. The medium is sterilized by autoclaving for 15 min, at 120° C., at a pressure of 1.2 bars.

A pre-culture is performed by inoculating a fragment of the fungus on a malt extract-agar (2%) (MA2) plate. The pre-culture is incubated from 3 to 10 days at 25° C. preferably. The fermenting tanks are typically inoculated with 150 fragments of pre-cultured fungi per litre of culture, wherein each fragment corresponds to a 3 mm or 6 mm diameter piece of fungi taken from the petri dish.

Preparation of inoculum using ground mycelium which is further encapsulated in a matrix: The matrix consists of polymers such as alginate salts, kappa-carrageenan salts and iota-carrageenan salts. The polymer solutions are prepared with 2.5 to 3% w/v of polymer in water.

The mycelium from a white-rot fungus is obtained from a pre-culture of said white-rot fungus in MA2 medium as described above. Fragments from this pre-culture are added to liquid medium ML2 and are incubated for 7 to 10 days at 25° C. under orbital shaking. When the mycelium presents a pellet-like aspect; it is further ground during 15 seconds at 20 rpm. The ground mycelium is mixed to a solution of polymer in a 1:1 ratio (v/v), and the mixture is further extruded with CaCl₂ or KCl solution (0.1 M for alginates, 0.4 M for carrageenans) such as to form beads. The fermenting tanks are typically inoculated with 150 beads per litre of culture.

### Example 6

The influence of the pre-culture of white-rot fungi on the decoloration process of the anthraquinonic dye NY3 using said white-rot fungi is described hereunder.

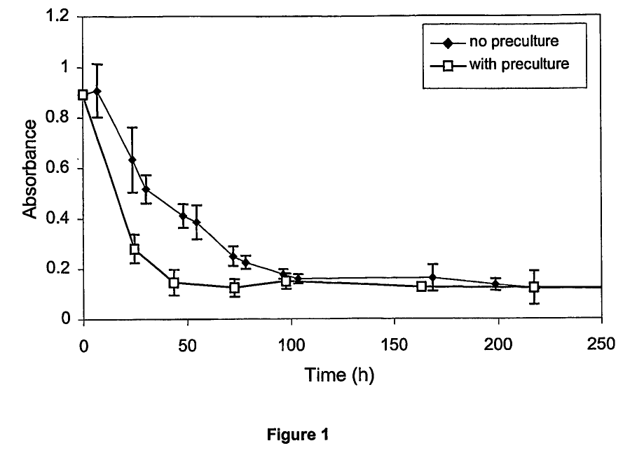

During this experiment, a pre-culture of a white-rot fungus was first performed in ML2 medium as described above. NY3 dye was later added to the fungal culture such as to obtain a concentration in NY3 of 0.7 g/l. The decoloration was measured spectrophotometrically. The results obtained are illustrated FIG. 1. The graph shows that the decoloration starts faster when the fungus has a significant biomass before the dye is added to the culture.

### Example 7

This example provides evidence for the positive effect of the addition of oxygen to a culture of a white-rot fungus on the performance of the white-rot fungus to decolorize the anthraquinonic dye NY3.

In general, white-rot fungi are aerobic organisms. They require a sufficient amount of oxygen to survive and to develop. Moreover, oxygen plays a major role in their oxidative fungal ligninolytic mechanism.

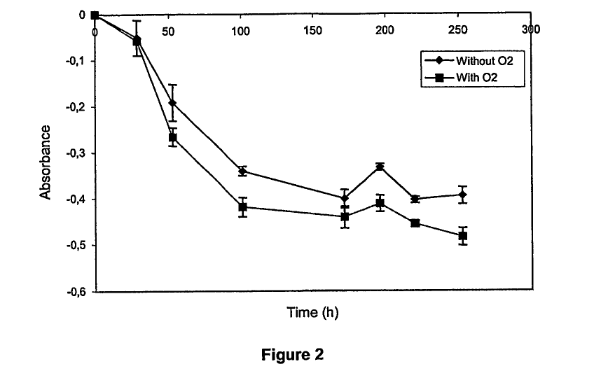

In this example the effects of an oxygen addition during culturing of the fungus on the bio-transformation of the dye by the white rot fungus was studied. The fungus Pycnoporus sanguineus MUCL 41582 was cultured in ML2 medium to which the NY3 dye was added and the effects of an addition of oxygen on the bio-transformation of the dye were investigated. Oxygen was added during approximately 15 minutes per day at the pressure of 0.2 bars. The decoloration of the anthraquinonic dye NY3 by Pycnoporus sanguineus was followed spectrophotometrically. FIG. 2 shows the favorable effect of this addition of oxygen on the decolorization of NY3 by white-rot fungi.

### Example 8

This example illustrates the decoloration of dyes as well as effluents when using a fungus, which has been immobilized on a support. Different supports were tested.

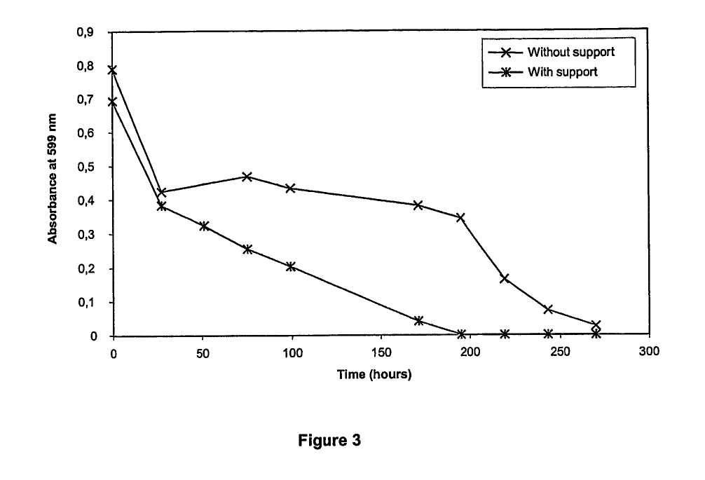

In a first example the decoloration of the anthraquinonic dye NY3 with white-rot fungi immobilized on a stainless-steel support was studied. The presence of an immobilizing support in agitated liquid culture is generally beneficial for the growth, the development and the performances of the fungus. In the setting of the follow-up of decoloration of dyes, the immobilization support should not interfere with the experiment; they must be neutral towards the dyes. The decoloration of the anthraquinonic dye NY3 by a fungal strain has been followed spectrophotometrically and a comparison of the results has been made between the speed of decoloration with or without immobilization. The results shown in FIG. 3 demonstrate that immobilization of the fungi on stainless-steel support plays an important role in the improvement of the decoloration of the liquid containing the NY3 dye.

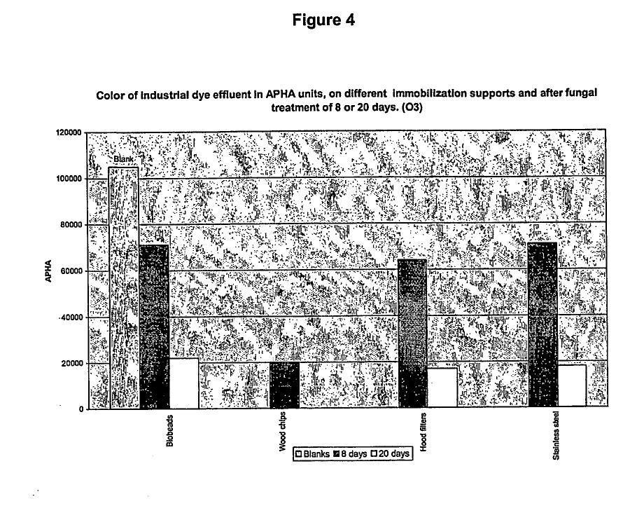

In a second example the decoloration of an industrial dye effluent was studied. The pretreatment consisted of an ozonolysis. The second step in the process for decoloration consisted of a treatment with a fungus immobilized on a support. Different immobilization supports, i.e. a wood support, biobeads, a stainless steel support and hoodfilters, were compared. The used fungus in this process was Pycnoporus sanguineus MUCL 41582. The efficiency of the different supports was determined by measuring the decoloration of the industrial dye 8 days or 20 days after treatment with the immobilized Pycnoporus sanguineus MUCL 41582. Results are shown in FIG. 4.

After eight days wood chips were the most efficient support, because in a first phase the wood chips adsorb the dyes present in the effluent. These dyes were then transformed by the fungus and the wood chips appeared uncolored at the end of transformation. For kinetic reasons, the transformation was enhanced as compared with the other supports, which are inert towards the dyes. Biobeads, hoodfilters and stainless steel showed approximately the same capabilities to immobilize the fungal biomass and to decolorize the effluent.

In another example, two other examples of effluents, 80949 and 80990, were treated by Perenniporia tephropora 41562 cultured on a wood chips support (no pretreatment). The effluent numbered 80949 is a textile effluent that contains mainly basic dyes for acrylic dying; the effluent numbered 80990 is a textile effluent that contains mainly dispersed dyes for polyester dying. In addition, a compost lixiviate was treated by Trichoderma harzanium MUCL 39887 (no pretreatment). The compost consisted of lixiviate from a composting society that was mainly colored by humic acids. Results are presented in table 3.

TABLE 3

| Effluents | 80949 | 80990 | Compost |
|---|---|---|---|
| Decoloration | 48% | 20% | 87% |

Results showed that the fungus Perenniporia tephropora 41562 cultured on a wood chips support can decolorize effluents containing basic dyes and dispersed dyes. The effluents were decolorized to 48% and 20% for the 80949 and the 80990 textile effluents respectively.

The compost lixiviate, treated with Trichoderma harzanium was decolorized up to 87%.

These results also show the efficiency of the fungus Trichoderma harzanium to degrade humic acids, which are present in the compost lixiviate, and therefore provide evidence for the interest of such immobilized fungal biomass for the improvement of green waste composting.

### Example 9

In this example, the decoloration of the anthraquinonic dye NY3 using white-rot fungi was studied. The effect of the addition of nutrients, i.e. a malt extract, as well as the adsorption of the dye on the biomass was addressed.

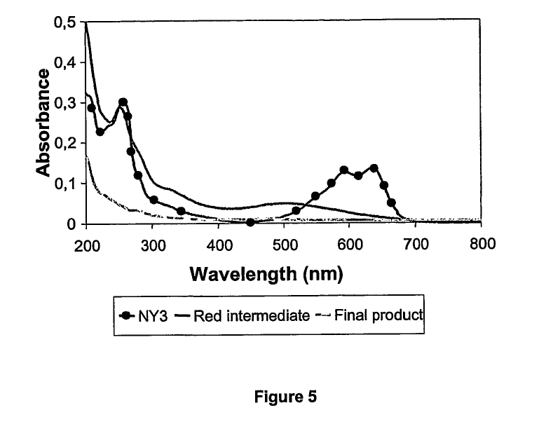

Previous experiments (see also example 8, FIG. 3) showed the evolution of the absorbance at 599 nm of the anthraquinonic dye NY3 during its bio-transformation by a fungal strain (FIG. 3). The absorbance measured at the beginning of the reaction, decreased quickly during the first hours of reaction (see FIG. 3). The spectrophotometric follow-up (FIG. 5) showed that a red intermediate presenting a peak at 500 nm was formed which then disappeared more slowly. The significant spectrum changes indicated that decoloration was caused by transformation of dyes rather than by a physical phenomenon of adsorption. This result was confirmed through a methanol desorption step of dyes adsorbed on the biomass, which was minimal.

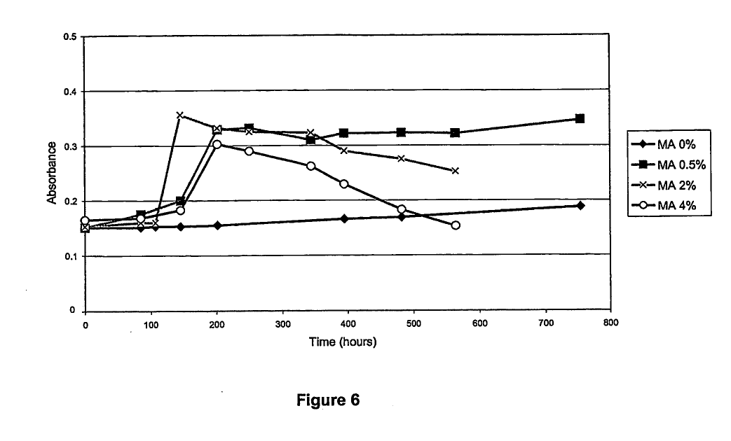

The present experiment (FIG. 6) shows that the speed of this second decoloration, i.e. the transformation of the red intermediate product in a colorless product, is function of the availability of nutrients. During this experiment, the evolution of the absorbance at 500 nm was studied with cultures of the strain Pycnoporus sanguineus MUCL 38531 containing different concentrations of malt. As shown on the graph in FIG. 6, the second decoloration of said red intermediate, was distinctly more efficient when the culture medium contained the highest concentration in malt.

### Example 10

This example illustrates the color reduction that can be obtained according to the process of the invention on real effluents. The treatment of industrial effluents using a process according to a preferred embodiment of the invention was studied. The effluents were submitted to ozone pretreatment, followed by a treatment with white-rot fungi.

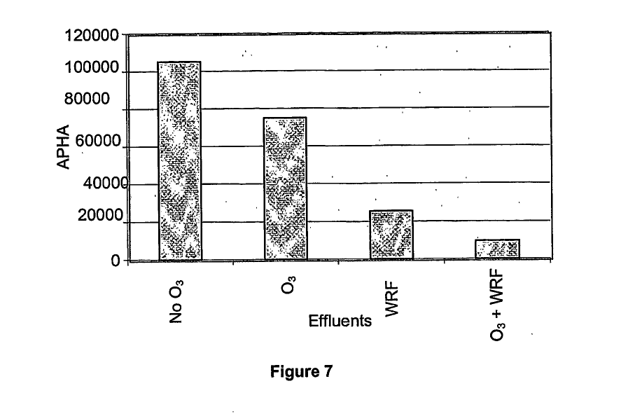

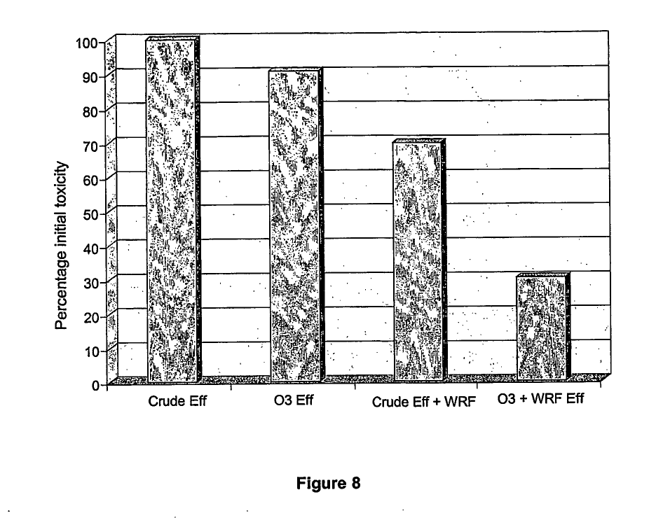

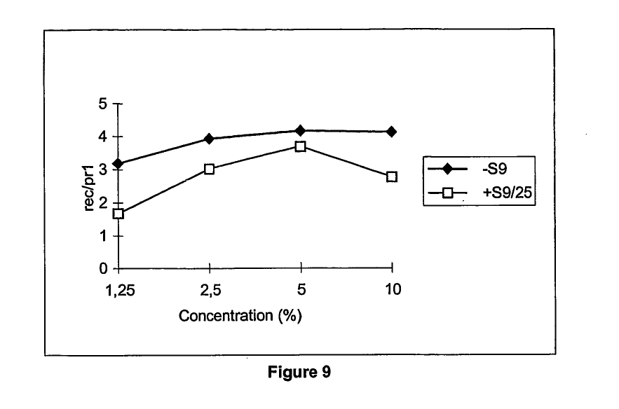

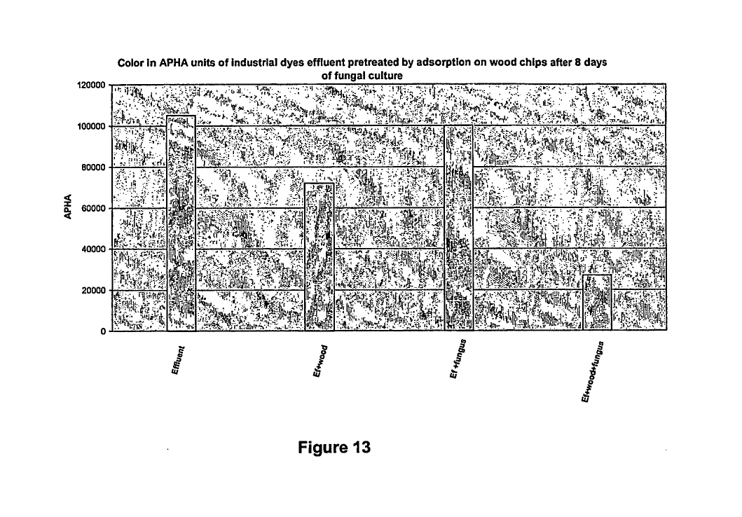

Because of the complexity of the effluents to analyze, the inventors proposed to characterize them, using four criteria a) their color (example 10, FIG. 7 and example 11, FIG. 13), b) their biodegradability (example 12, table 4), c) their toxicity on Caco2s human cells (example 13, FIG. 8), which were used as model of the human intestinal epithelium and d) the mutagenic character (example 14, FIGS. 9 to 12) of said effluents before and after treatment.

Effluent samples from the dye industry Yorkshire Europe (previously Crompton and Knowles), were collected daily during 15 days. These samples were mixed and constituted the crude effluent sample. Besides, some samples of ozone pretreated effluents were collected as described above, at same time. Each sample were diluted 5 times with a malt medium 2% (w/v). The crude effluents or pretreated effluents samples were inoculated with fragments of Pycnoporus sanguineus MUCL 41582. The culture was incubated for 2 to 3 weeks at 25° C., at 125 rpm.

The effect of said treatments on the color of said effluents was studied. As shown FIG. 7, the treatment with ozone only decreased the coloration of 30%, whereas the applied fungal treatment decreases the color of about 80%. The application of the process with ozone pretreatment and white-rot fungi treatment permits a reduction of the coloration of about 90%.

### Example 11

This example illustrates a pretreatment of liquid waste using wood chips as an adsorption step. A sample of an industrial dye effluent was collected and presents an initial color of 105000 color units (APHA). Wood chips were added and the pretreatment was applied during 24 hours. Color was measured (see “Ef+wood” in FIG. 13) and showed a decrease up to 72 000 APHA, which is less colored than the result obtained with ozonolysis.

This pretreated effluent was then incubated in the presence of Pycnoporus sanguineus MUCL 41582 and 2 percent (w/v) malt during 1 week (see “Ef+wood+fungus” in FIG. 13) and compared with the same assay without pretreatment (see “Ef+fungus” in FIG. 13). Results showed that the pretreatment alone provoked a decoloration of 31%, and the fungal treatment alone provoked a decoloration of only 5% in one week, while the combination enhanced the decolorization up to 74%. Moreover, as mentioned in example 10, two to three weeks were necessary to the fungus alone to decolorize the effluent in the same range as what is obtained here in one week with the combination proposed. Therefore, this system allows to reduce by up to a third the contact time needed. Finally, as mentioned above the effects obtained by adsorption present the advantage of being considerably less expensive, since wood shavings are inexpensive.

### Example 12

The problem with the effluents from dye or textile industries is that they are not biodegradable. Therefore, when they are dumped into a biological wastewater treatment plant, they are not degraded but just diluted by other waters.

In this example, the biodegradability of effluents was measured before and after treatment of said effluents. The biodegradability of the crude effluent, the ozonised effluent, the crude effluent treated with white-rot fungi (crude Eff+WRF) and the ozonised effluent treated with white-rot fungi (O3+WRF Eff), was measured as the ratio BOD5/COD.

BOD is the abbreviation for the Biological or Biochemical Oxygen Demand. It is defined as the amount of oxygen (mg/l or mg/kg) used by the non-photosynthetic microorganisms at 20° C. to metabolize biologically degradable organic compounds. Conventionally, we use the BOD₅, which corresponds to the amount of oxygen consumed after 5 days of incubation. The measurement of the parameters for the BOD₅ was done using a manometric method which relies on a difference of pressure and of the decrease in pressure is measured by the Oxitop® system.

The measurement of the parameters for the COD was done through a normalized method (NFT 90.101 or DIN 38 409-H41-1). The method used was a photometric determination of chromium (III) concentration after 2 hours of oxidation with potassium dichromate/sulfuric acid/silver sulfate at 148° C. A 620 nm filter was used.

The results are shown in following table 4. Ozonolysis does not allow to enhance biodegradability, nor does the fungal treatment used alone as such (+7%). On the other hand, the combined process, i.e. ozonolysis and fungal treatment, doubles the biodegradability and is therefore more efficient than the sum of any individual processes.

TABLE 4

| Effluents | Biodegradability |
|---|---|
| Crude effluent | 21% |
| Ozonised effluent | 20% |
| crude Eff + WRF | 28% |
| O₃ + WRF Eff | 41% |

### Example 13

The detoxifying effect of the process according to a preferred embodiment of the invention was studied by measuring the toxicity of said effluents on Caco2 cells before and after treatments. Caco2 cells were cultivated in Dulbecco's modified Eagle's medium (DMEM, Ref. 5796 from Sigma) supplemented with 10% heat inactivated foetal bovine serum (Gibco) and 1% non-essential amino acids (Gibco). The cells were incubated for 48 h at 37° C. Increasing concentration of the effluents were tested on the Caco2 cells, a) crude effluent, b) ozone pretreated effluent, c) crude effluent treated with white-rot fungi and d) ozone pretreated effluent treated with white-rot fungi. After incubation for 48 h at 37° C., the toxicity of the different effluents was measured by submitting the cells to a solution of tetrazolium salt (MTT, 3(4,5-dimethylthiazolo-2-yl)-2,5-diphenyletrazolium bromide). The transformation of MTT to a red product, which is measured at 570 nm, gives indication on the production level of mitochondrial succinate dehydrogenase, enzyme which indicates the survival level of the cell.

The results obtained are presented FIG. 8, which shows a comparison between the toxicity of the effluents (concentration 1%) on Caco2 cells before and after ozone pretreatment and before and after treatment with white-rot fungi, wherein, crude Eff is crude Effluent, 03 Eff is ozonised effluent, crude Eff+WRF is crude effluent treated with white-rot fungi and 03+WRF Eff is ozonised effluent treated with white-rot fungi.

It can be seen from this figure, that the ozonisation treatment only reduces the toxicity of 10%, whereas when the crude effluent is treated with white-rot fungi a 30% decrease of the toxicity is observed. The best results were obtained with ozone pretreated effluent which have been further treated with white-rot fungi, as a 70% decrease in toxicity is measured. This proves that the combination of ozone pretreatment with white-rot fungi treatment is more efficient than the sum of any individual processes.

### Example 14

The mutagenicity of said effluents was studied before and after treatments. The tests of genotoxicity measure the capacity of a compound to damage the DNA, this process being associated to the carcinogenesis of a compound. A method named VITOTOX™ has been developed, that uses the SOS response system of bacteria. The recombinant bacterial strains used in this test contains different reporter genes, and are constructed with Salmonella typhimurium strains. The reporter system contains luciferase gene. In case of damage of the DNA of the strain rec2, the SOS response system will be activated, as well as the luciferase gene. The luciferase activity can be measured by the light emission and is dependent of the genotoxicity of the compound tested. The response measured is compared to the one obtained in presence of another bacterial strain pr1. A measure wherein the response rec/pr1 is higher than 1,5 indicates the mutagenicity of the sample. Moreover, when an organism meets a non-natural substance called xenobiotic, the liver transforms it to facilitate the excretion by the kidneys. Therefore, some non-mutagenic compounds can be transformed into genotoxic products by metabolic activation. For this reason, the test is coupled with an analysis of the sample to be tested after incubation with an exogenous metabolic extract. In our case, the mix S9/25 is a solution of hepatic hare extract which contains enzymes required for the detoxification of the xenobiotics ingested by the animal.

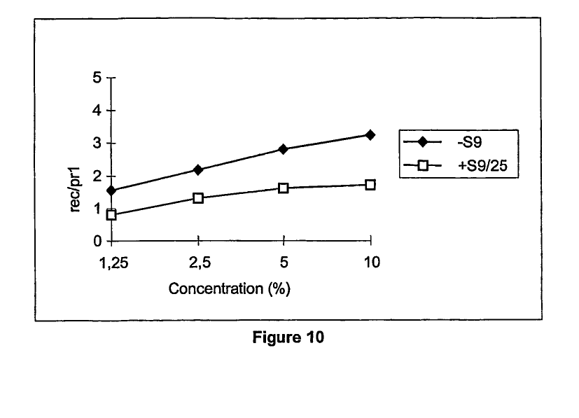

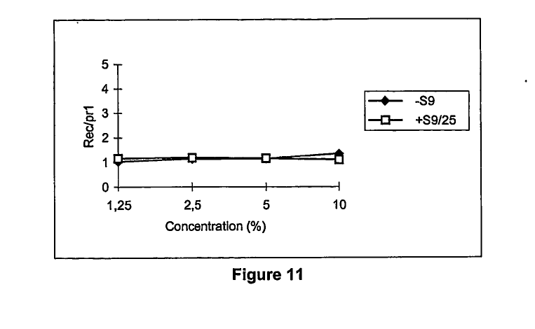

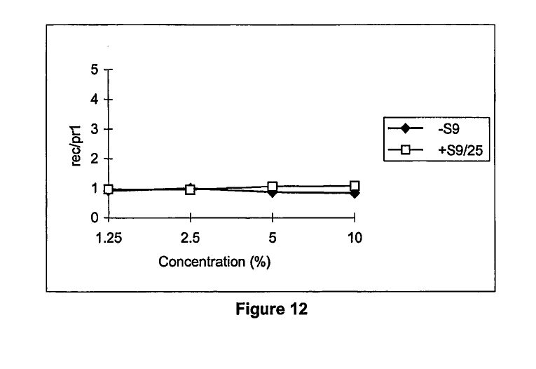

FIG. 9 shows the induction of Salmonella typhimudium SOS system (rec/pr1) according to the percentage of concentration in crude effluent (Crude Eff). FIG. 10 shows the induction of Salmonella typhimurium SOS system (rec/pr1) according to the percentage of concentration in ozonised effluent (03 Eff). FIG. 11 shows the induction of Salmonella typhimurium SOS system (rec/pr1) according to the percentage of concentration in Crude effluent treated with white-rot fungi (Crude Eff+WRF). FIG. 12 shows the induction of Salmonella typhimurium SOS system (rec/pr1) according to the percentage of concentration in ozonised effluent treated with white-rot fungi (O3+WRF Eff).

By comparing FIGS. 9, 10, 11 and 12, it can be seen that the crude effluent is highly mutagenic, with or without metabolic activation (S9) for all the concentrations tested. The same can be observed for the ozonised effluent without metabolic activation. With metabolic activation the ozonised effluent is mutagenic from a concentration of 2.5%. The crude and ozonised effluents which have been further treated by white-rot fungi do not show any mutagenicity at the concentrations tested with or without metabolic activation. Such a result shows the detoxifying effect of white-rot fungi on effluents from dye industries. The results of decoloration, biodegradability, toxicity and mutagenicity are summarized table 5.

TABLE 5

| | | | Toxicity on | |
|---|---|---|---|---|
| Effluents | Color | Biodegradability | Caco2 | Mutagenicity |
| Crude effluent | 100% | 21% | 100% | yes |
| Ozonised effluent | 71% | 20% | 90% | yes |
| crude Eff + WRF | 24% | 28% | 69% | no |
| O3 + WRF Eff | 9% | 41% | 29% | no |

From these results it can be seen that the process of the invention permits a 90% decrease of the color of industrial effluent, further more the biodegradability of said effluent after treatment is doubled, 70% of the toxicity has been removed and the mutagenicity of said effluent has been eliminated.

### Example 15

The present example illustrates biochemical and performance characteristics of laccases excreted by highly efficient dye-transforming white-rot fungi. Selected white-rot fungi form the group consisting of Coriolopsis polyzona (MUCL 38443), Perenniporia ochroleuca (MUCL 41114), Pycnoporus sanguineus (MUCL 38531), Pycnoporus sanguineus (MUCL 41582), Perenniporia tephropora (MUCL 41562), Trametes versicolor (MUCL 38412) and Clitocybula dusenii b11 (DSM 11238), were used to produce laccases using draw-and-fill “Kefir principle” culture. Isoelectric points (pls), isozyme pattern of and effect of pH as well as temperature on the laccases were determined.

Table 6 summarizes the biochemical and performance characteristics of laccases excreted by highly efficient dye-transforming white-rot basidiomycetous fungi.

TABLE 6

| | temperature | | pH | | | |
|---|---|---|---|---|---|---|
| | stability [%] | | stability [%] | | | |
| | (residual | optimal | (residual | | MW | |
| | activity at | temperature | activity at | optimal | (dimer) | pl |
| Fungal strain | 70° C.) | [° C.] | pH 4/6) | pH | [kDa] | (pH) |
| Coriolopsis polyzona | 9 | 40 | 19.4/396^{*)} | 2 | 68 (147) | 5.0, 5.2 |
| Perenniporia ochroleuca | 29 | 50 | 5/1379^{*)} | 2 | 63 (144) | 4.5, 5.0 |
| Pycnoporus sanguineus | 58 | 50 | 2.7/45.8 | 2.5 | 70 | 4.4, 5.0, 5.3 |
| MUCL 38531 | | | | | | |
| Pycnoporus sanguineus | 70 | 50 | 0.5/617^{*)} | 2.5 | 65 (136) | 4.3 |
| MUCL 41582 | | | | | | |
| Perenniporia tephropora | 74 | 50 | 10.1/63.8 | 2 | 69 (148) | 5.0, 6.2 |
| Trametes versicolor | 35 | 40 | 1.9/48.6 | 2 | 67 | 4.2, 4.5 |
| Clitocybula dusenii | 1 | 40 | 1.2/36.7 | 2.5 | 66 | 4.5, 4.7 |

^{*)}Activating effects were observed after incubation at pH 6 for 24 h.

### Example 16

The decoloration of effluent by purified laccase enzymes from white-rot fungi with and without ozone pretreatment was studied. This experiment shows the role of ligninolytic enzymes of type laccases isolated from white-rot fungi, in the decoloration of industrial effluent. This experiment was conducted with industrial effluents contaminated with dyes. Samples from these effluents have been pretreated with ozone; the other samples constitute the crude effluents as collected on the site. The laccase used was isolated from a culture of Pyonoporus sanguineus MUCL 41582. They were concentrated by ultrafiltration and purified by anion-exchange chromatograpy, their molecular weight is 65 kDa and their gene contain following sequences (primers used for the Polymerase Chain Reaction:

lac 1 5′ ACT GTG ACG GTC TTC GC 3′,
lac 3: 3′ GTA GGT AAG GTA GAA GTG CCG 5′,
lac 4: 5′ CAC TGG CAT GGC TTC TTC CA 3′,
lac 5: 5′ AAG TCG ATG TGG CAG TGG AGG 3′)

a) with the primer lac 5 for the sequencing reaction:

CCTGAAACCGGATGGTGACGTTGTCGCCGGGCGTGCCGGTGCTCACGACG
TCGCGGAAGACCGGGTTGTCGTAGTTGTACTCGCTGCTTCCGGCGCTTCG
GACGACAGCGAAGGTGTGCTGCAGTGATAGTGAGGTATAAATTTCTCATC
AGATGCGTGATGAGCGGACGTACACCGTGCAGGTGGAAAGGGTGAGGGCT
GCCAGGAGCATTGGCAGTGGCGGGGAAGGAGATCTCAATAGAGGCGTTGC
TCGGCAGAACGTAGACGCTGCCTTCCGGGGACCAGGTCCTGTGCGGCCTG
AGCGCCGCTGAGAATCTGGAGCAGGACCGGCACGGAGGGCGGGACGAAGG
AGTGGTCATTGATGAAGAAGTTCGTGCCGTTCTATATGGACATCAGACAU
GTCCCGAATTGTAGGACGCCGGTGCGAATGCTCACGAAGTTGAAAACCAT
GTTCAGCGGCTTGTCGACACCTCCGGGCTCGGGGCGGCCAGGCTATGATA
TGATATATGGGTTTCACTC

b) with the primer lac 4 for the sequencing reaction:

AGTCAACCAGTGCCCCATCGCTTCGGGCCATTCGTTCTTGTACGACTTCC
AGGTCCCCGACCAAGCAGGTAATGAATTCGACACTCCCCTCCACTCGGTG
ATACTGACCCTTTTNAACTAGGAACNTTCTGGTATCACAGTCATCTATCC
ACCCAGTATTGTGATGGATTGAGAGGTCCCTTCGTCGTCTACGACCCGAA
TGATCCCCAGGCCAGCTTGTATGACAUGACAACGGTGAGCAGATTGGAGC
CANGTCACATACTCTCTTCTTTCATACTGAAGCCACTCCCAGACGACACT
GTGATTACTTTGGCCGACTGGTACCATCTTGCCGCTAAAGTTGGCCAGCG
CTTCCCGTACGCCTTCTCCTATGTGTCTCGATGTTTCAAGTGGACTCATT
GATGTGATGACAGAGTTGGCGCGGATGCGACTCTGATTAACGGGCTTGGT
CGGACCCCCGGNACGACCTCTGCTGACCTGGCGATTATCAAGGTCACACA
GGGCAAGCGGTTCGTGCCCATTTATCAACCTCTAATCGCTTGNCTCTGAC
AATTCTGCTCTTT

c) with the primer lac inter 3 for the sequencing reaction:

5′ GGA ACT GGT TGC TCT GGC AGT ACG 3′

CGGGGACCAGGTCCTGTGCGGCCTGAGCGCCGCTGAGAATCTGGAGCAGG
ACCGGCACGGAGGGCGGGACGAAGGAGTGGTCATTGATGAAGAANTTCGT
GCCGTTCTATATGGACATCAGACATTGTCCCGAATTGTAGGACGCCGGTG
CGAATGCTCACGAAGTTGAAAACCATGTTCAGCGGCTTGTCGACACCTCC
GGGCTCGGGGCGGCCAGGCTATGATATGATATATGGGTTTCA

Laccase from strain Pycnoporus sanguineus MUCL 41625 was also sequenced and gave following results:

a) with primer lac 5 for the sequencing reaction:

ATNGTTGGTCTGAAACCGGATGGTGACGTTGTCGCCGGGGGTACCGGTGC
TCACGACGTCACGGAAGACCGGGTTGTCGTAGTTGNACTCGCNGCTTCCG
GCGCTTCGGACGACAGCGAAGGTGTGCTGCAGTGATTGTTAGAAATCAGC
ACGTACACCGTGCAGGTGGAAGGGGTGAGGGCTGCCAGGAGCATTGGCAG
TGGCGGGGAAGGAGATCTCAATAGAGGCGTTGCTCGGGAGGACGTACACG
CTGCCTTCCGGGACCAGGTCCTGTGCAGCCTGAGCGCCGCTGAGAATCTG
GAGCAGGACCGGCACGGAGGGTGGGACGAAAGAGTGGTTGTTGATGAAGA
AGTTCGTGCCGTTCTATATAGACATTAGACATTGTTCTAAACCATAGGAC
GCCGGCGGCGTATATACTCACGAAGTTGAAGACCATGTTGAGCGGCTTGG
TCGACACCTCCGGGCTCGGGGCGTCCAGGCTATAATATGAGAGATTAGTT
TTCATCTACTCGAATATTTANATCTGTACGAGAC

b) with primer lac 4 for the sequencing reaction:

AGTCAACCAGTGCCCCATCGCTTCGGGCCATTCGTTCTTGTACGACTTCC
AGGTTCCCGACCAAGCAGGTAACGAAATTTTGACACCCCCCTCCACTCGG
TGATACTGATCCTTCTTTGATTAGGAACTTTCTGGTATCACAGTCATCTT
TCCACCCAGTATTGTGATGGATTGAGAGGCCCCTTCGTCGTCTACGACCC
GAATGATCCCCAGGCCAGCTTGTATGACATTGACAACGGTGAGTAATTTT
GAGCCAAATGACACACTCTCTTGTCTTATACTGAAATCCCTACCAGACGA
CACTGTGATTACTTTGGCCGACTGGTACCATCTTGCCGCCAAAGTTGGAC
AGCGCTTCCCGTACGCCTTGTCTTATGTGTCTCGATGTTTCAAGTGGACT
CATTGTCGTGATGACAGAGTTGGCGCGGATGCGACTCTGATTAACGGGCT
GCTGATCTGGCGGTTATCAAGGTCACACAGGGCAAGCGGTTCGTGTCCAA
TATCAACTTATACTCGNTTTGCT

Laccase from strain Pycnoporus coccineus MUCL 38525 was also sequenced and gave following results:

a) with primer lac 5 for the sequencing reaction:

CTGGCCGGTGCNCACGACGTCGCGGANGANCGGGTTATCGTAGTTGTACT
CGNGGCTTCCGGAGCTTCGGACGACAGCGAAGGTGNGCTGNGTGTGATTG
TTAGCTATCAACTCATCATCAGATGCGCGAGGACCGGACNTACACCGTGC
AGGTGGAAGGGGTGAGGNGTGCCAGGAGCATTGGCAGTTGCGGGGAAGGA
GATCTCAATAGACGAGTTGCTCGGGAGAACGTAGACGCTGCCGTCCGGAA
CGAGGTCCTGCGCGGCCTGAGCACCGCTGAGAATCTGGAGCAGAACCGGG
ACGGAGGGTGGGACAAAGGAGTGATTGTTGATGAAGAAGTTGGTGCCGTT
CTGCAAGGACATCANANATTGTCCCAAAATGGCGCGAAGGCAATGCTCAC
NAAGTTGAAAGACCATGTT

b) with primer lac 4 for the sequencing reaction:

GTCAACCAGTGCCCCATCGCTTCGGGCCATTCGTTCTTGTACGACTTCCA
GGTTCCCGATCAAGCAGGTAATGAAATTCGACCNGNTCTTTCATTCGGCG
GGCCTGATCTC

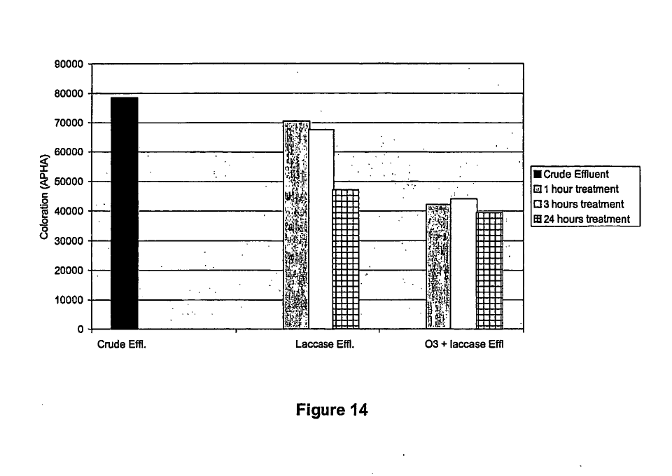

The mixture enzymes/effluents has been incubated at 40° C. in a water bath. The decoloration of said effluents has been measured after 24 hours of incubation. The enzyme concentration was 2%. The decrease in coloration was measured after 1, 3 and 24 hours treatment. As shown in FIG. 14, the coloration of the sewage has been decreased visibly. It can be also observed that the pretreatment with ozone permits to reach in 1 hour a level of decoloration equivalent to the one obtained after 24 hours of treatment in absence of said pretreatment.

### Example 17

The following example illustrates the effect of immobilisation of active agents in the treatment of dye-contaminated effluents. This example describes the decoloration of an anthraquinonic dye by purified laccase under different conditions, i.e. used as a solution, or immobilised on wood chips.

One technique consisted of treating the dye solution with a solution of laccases. One milliliter of NY3 dye at a concentration of 0.7 g/liter was treated with 100 microliter of laccase concentrated from Pycnoporus sanguineus MUCL 41582 during 24 hours at 40° C.

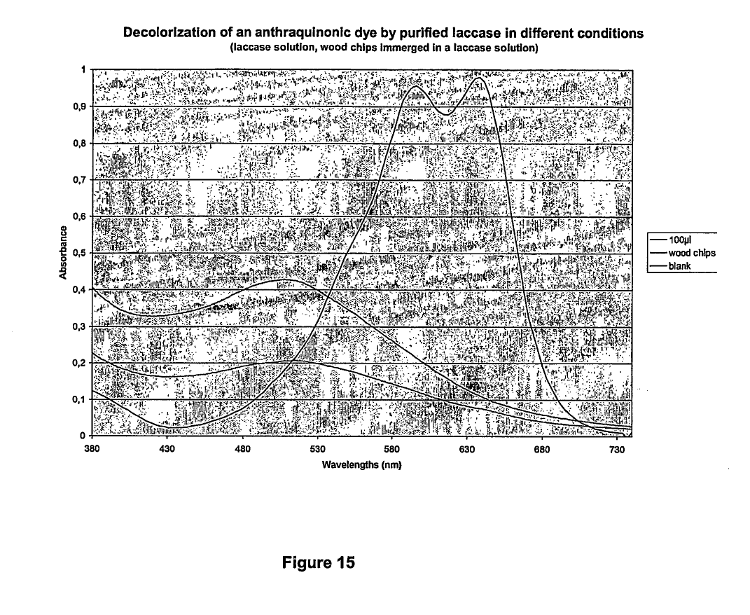

A second technique consisted of immersing wood chips in a laccase solution. One milligram of wood shaving was immersed during two seconds in the same concentrated laccase. The piece of wood containing adsorbed laccase was then immersed into one milliliter of NY3 dye at a concentration of 0.7 g/liter and incubated during 24 hours at 40° C. The reaction was followed spectrophotometrically and results are shown in FIG. 15.

It can be observed that the initial dye has completely been decolorized in the two techniques since an absorbance peak at the initial 595 nm could not be detected anymore. This result was due to a transformation, not to adsorption as indicated by the spectral change (new peak at 500 nm, as observed previously in example 9, FIG. 5). Nevertheless, the transformation was more complete when the laccase was adsorbed on wood as an absorbance of 0.2 instead of 0.45 was observed when the laccase was added as a solution.

A simple and inexpensive way to extract, immobilize and concentrate active agent comprises the following process. A white-rot fungus is cultured in a liquid medium until enzyme production has reached a significant amount. Then a support, preferably a wooden support such as wood chips is added the supernatant. The enzymes released in the extracellular medium can then easily be adsorbed on this wood support. Such method enables to work with the enzymes produced by the fungi instead of working with a complete fungal culture.

Such method also avoids the need to concentrate and purify the enzymes out of the cultures by means of highly expensive and complicated techniques. The above-described method also enables to limit the costs, and provides a method, which can be used in industrial processes for the environmental treatments.

1. A process for the treatment of liquid waste, comprising the steps of:
(a) submitting said liquid waste to a pretreatment; and
(b) submitting said pretreated liquid waste to the action of white-rot fungi or active agents thereof.

2. The process according to claim 1, wherein said white-rot fungi active agents comprise hydrolytic enzymes, cellulolytic enzymes, or ligninolytic enzymes.

3. The process according to claim 2, wherein said white-rot fungi active agents consist essentially of laccase enzymes.

4. The process according to claim 1, wherein said pretreatment is ozonizsation.

5. The process according to claim 1, wherein said pretreatment comprises adsorption of said waste on a biodegradable support.

6. The process according to claim 1, wherein said liquid waste, is dye-containing liquid waste, comprising azo dyes and anthraquinones dyes

7. The process according to claim 1, wherein said liquid waste comprises humic acids.

8. The process according to claim 1, wherein said white-rot fungi are selected from the group consisting of the genus Acanthophysium, the genus Aleurobotrys, the genus Aleurodiscus, the genus Amphinema, the genus Amylostereum, the genus Armillaria, the genus Aspergillus, the genus Asterostroma, the genus Auricularia, the genus Botryobasidium, the genus Botryohypochnus, the genus Calocera, the genus Chaetomium, the genus Cladorrhinum, the genus Clitocybula, the genus Columnocystis, the genus Coriolopsis, the genus Cystostereum, the genus Daedalea, the genus Daedaleopsis, the genus Dichomitus, the genus Dichostereum, the genus Echinodontium, the genus Fibulomyces, the genus Fomitopsis, the genus Fusarium, the genus Ganoderma, the genus Grifola, the genus Hapalopilus, the genus Humicola, the genus Hymenochaete, the genus Hyphoderma, the genus Hyphodontia, the genus Hypochnicium, the genus Inonotus, the genus Irpex, the genus Laurilia, the genus Laxitextum, the genus Lentinus, the genus Lenzites, the genus Lentinula, the genus Leucogyrophana, the genus Lycoperdon, the genus Marasmius, the genus Merulius, the genus Mycoacia, the genus Myrothecium, the genus Paecilomyces the genus Panellus, the genus Penicillium, the genus Peniophora, the genus Perenniporia, the genus Pestalolia, the genus Phanerochaete, the genus Phellinus, the genus Phlebia, the genus Pholiota, the genus Pleurotus, the genus Polyporus, the genus Poria, the genus Punctularia, the genus Pycnoporus, the genus Resinicium, the genus Schizophyllum, the genus Scytinostroma, the genus Steccherinum, the genus Trametes, the genus Trichoderma, the genus Tyromyces and the genus Vararia.

9. The process according to claim 1, wherein said white-rot fungi are selected from the group consisting of the genus Acanthophysium, the genus Coriolopsis, the genus Clitocybula the genus Cystostereum, the genus Ganoderma, the genus Paecilomyces, the genus Perenniporia, the genus Phellinus, the genus Phlebia, the genus Pycnoporus and, the genus Trametes.

10. The process according to any of claim 1, wherein said white-rot fungi are selected from the group consisting of Acantophysium bisporum MUCL 32213, Coriolopsis polyzona MUCL 38443, Cystostereum murraii MUCL 33747, Ganoderma subamboinense MUCL 38859, Lentinus cladopus MUCL 28678, Lentinula edodes MUCL 29756, Lenzites betulina MUCL 38559, Merulius tremelosus MUCL 38065, Paecilomyces variotii MUCL 21705, Perenniporia medulla-panis MUCL 40050, Perenniporia ochroleuca MUCL 41114, Perenniporia tephropora MUCL 41562, Phanerochaete chrysosporium MUCL 19343, Phanerochaete ericina MUCL 33845, Phellinus rimosus MUCL 38446, Phlebia subserialis MUCL 33724, Polyporus brumalis MUCL 29280, Polyporus ciliatus MUCL 40141, Pycnoporus cinnabarinus MUCL 38520, Pycnoporus coccineus MUCL 38525, Pycnoporus sanguineus MUCL 41625, Trametes versicolor MUCL 38412 and MUCL 28407.

11. The process according to claim 1, wherein said white-rot fungi are selected from the group consisting of Clitocybula dusenii DSM 11238, Trichoderma harzanium MUCL 29707 and Trichoderma longibrachiatum MUCL 39887.

12. The process according to claim 1, wherein said white-rot fungi are grown in a media containing malt extract in a concentration ranging from 0.5 to 8 percent by weight to volume.

13. The process according to claim 1, wherein said white-rot fungi are added to said liquid waste in an encapsulated form, in a matrix consisting of polymers.

14. The process according to claim 13, wherein said polymers are selected from the group consisting of alginate salts, carrageenan salts, iota-carrageenan salts, maltodextrin, whey protein concentrate (WPC), skimmed milk powder (SMP), dried yeast autolysate (YA), dried yeast extract (YE), corn starch (CS), modified starch (MS), and polyvinylalcohol.

15. The process according to claim 1, wherein said white-rot fungi are employed in an immobilized form.

16. The process according to claim 15, wherein said white-rot fungi are immobilized on a support selected from the group consisting of stainless steel support, polymer support and wood support.

17. The process according to claim 1, wherein the white-rot fungi active agents are employed as raw preparation, as purified enzymes, or in an immobilized form.

18. The process according to claim 17, wherein the white-rot fungi active agents are immobilized on a wood support.

19. The process according to claim 1, further comprising adding an inductor to white-rot fungi culture, preferably after said fungi has reached a significant bio-mass.

20. The process according to claim 19, wherein said inductor has an azo anthraquinonic or a stilbenic dye structure.

21. The process according to claim 19, wherein said inductor has a phenolic, aromatic or metallic structure.

22. The process according to claim 1, further comprising incubating said white-rot fungi in said pretreated liquid waste.

23. The process according claim 22, wherein a suitable amount of nutrients are added during the incubation of said white-rot fungi in said pretreated liquid waste.

24. The process according to claim 23, wherein the nutrients are added in an amount ranging from 0.5 to 4 percent in weight per volume.

25. The process according claim 22, wherein a pH during the incubation of said white-rot fungi in said pretreated liquid waste is ranging from 4 to 9 and a temperature of incubation is ranging from 20 to 45° C.

26. The process according to claim 22, wherein a pH during the incubation of said active agents in said pretreated liquid waste is ranging from 2 to 7 and a temperature of incubation is ranging from 20 to 70° C.

27. Ihe process according to claim 22, wherein a pH during the incubation of said white-rot fungi or active agents thereof in said pretreated liquid waste is ranging from 1 to 9 and a temperature of incubation is ranging from 18 to 70° C.

28. The process according to claim 22, wherein said white-rot fungi or active agents thereof, are incubated with said pretreated liquid waste for 2 hours to 14 days.

29. The process according to claim 22, wherein said white-rot fungi or active agents thereof, are incubated with said pretreated liquid waste for 20 minutes to 14 days.

30. The process according to claim 1, wherein said fungi or active agents thereof obtainable after step b) are separated.

31. The process, according to claim 30, wherein said separated fungi or active agents thereof are reused in said process.

32. A method of using the fungi or active agents thereof obtainable after step b) of the process according to claim 1 into a green waste composting process.

33. A method for immobilizing fungal active agents on a support comprising the steps of:
culturing a fungus in a liquid medium,
immersing a support with the supernatant of said fungal culture, and
immobilizing the active agents of said fungi on said support, said agents being released in the fungal culture supernatant.

34. The method according to claim 33 wherein said support comprises a wood support.

35. The method according to claim 34, wherein said wood support is immersed with said fungal culture supernatant in a quantity comprised between 0.1 and 100 g per liter of fungal culture supernatant.

36. The method according to claim 34, wherein said wood support is immersed in said fungal culture supernatant from 1 second to 24 hours.

37. The process according to claim 22, wherein oxygen is added during the incubation of said white-rot fungi in said pretreated liquid waste.
